(19) United States
(12) Patent Application Publication
(10) Pub. No.: US 2026/0071511 A1
(43) Pub. Date: Mar. 12, 2026

(54) HARNESS

(71) Applicant: BAKER HUGHES ENERGY TECHNOLO GY UK LIMITED, Bristol (GB)

(72) Inventors: Simon David EVANS, Bristol (GB); David Ronald SOUTHERN, Bristol (GB)

(21) Appl. No.: 19/108,547

(22) PCT Filed: Sep. 5, 2023
(86) PCT No.: PCT/GB2023/052290

§ 371 Date: Mar. 4, 2025

(30) Foreign Application Priority Data
Sep. 9, 2022 (GB) 2213248.4
Sep. 4, 2023 (GB) 2313469.5

(51) Int. Cl. E21B 33/038; E21B 41/00; H01R 13/52

(52) U.S. Cl. CPC E21B 33/0385; E21B 41/0007; H01R 13/521

(57) ABSTRACT

A method and apparatus for connecting at least one elongate transmitting element to a transmitting connector via at least one intermediate transmitting element, and a system. The apparatus comprises a transmitting connector locatable at an outer surface of a housing that defines a chamber: at least one elongate transmitting element locatable at least partly within the housing; at least one intermediate transmitting element associated with the transmitting connector and couplable to the elongate transmitting element; and a retaining element locatable within the housing and comprising a first retaining portion and a further retaining portion, the first retaining portion being for retaining the elongate transmitting element at a particular position with respect to the retaining element, and the further retaining portion being for engaging with a securing region associated with the housing; the retaining element is for retaining the elongate transmitting element at a predetermined position with respect to the housing.

The present invention relates to a method and apparatus for interconnecting elements in a subsea environment. In particular, but not exclusively, the present invention relates to a harness connector solution that utilises a mechanical connector such as a sealing gland in a subsea module such as a subsea control module (SCM) or power and communications distribution module (PCDM).

Subsea distribution systems (SDSs) often include units that provide communication from subsea controls to locations above sea-level. SDSs are commonly used in the production of oil and gas, where it may be required to perform functions including the distribution of hydraulic power and electrical power, communication, and chemical injection. In subsea distribution systems, jumpers and harnesses are a common component, providing a medium of transfer and connection between individual devices in subsea conditions.

A harness sometimes includes a length of hose or cable with a termination and connection technology at each end. Connection technologies sometimes include both a plug and a receptacle. The type of connection technology depends on the type of connection: a wet-mate connector is sometimes designed to be mated or unmated in wet environments, whilst a dry-mate connector is sometimes designed to be mated or unmated in dry environments. There are numerous designs of wet-mate connectors, generally focusing on providing a solution to the ingress of seawater into electrical components in harness or else to the problem of corrosion of electrical components. That is to say wet mate connectors may help to prevent the ingress of seawater into electrical components of the connector, harness or the like. Dry-mate connectors often have different designs because the plug and receptacle in this instance are typically fully mated before submersion in a fluid.

A component of a subsea distribution system is sometimes a Subsea Control Module (SCM). This is an independently retrievable unit used to provide well control functions. The SCM often has a number of external receptacles on its outer cover into which electrical cabling or cabling that carries communication can connect via wet-mate under the water. These are sometimes known as “wet-mate electrical connectors.” Wet-mate electrical connectors may be used to connect the SCM to other devices in the subsea distribution system.

The SCM often contains a number of sub-modules which may provide different functions. These sub-modules are often standalone devices which are often made by a third party and added into the SCM during assembly. A sub-module may, for example, implement a corrosion monitor or distribute power. The sub-modules of the SCM are often connected via harnesses to the external receptacles from the inside of the SCM cover. Aptly the sub-modules are packaged modules or instruments or the like. This enables the sub-modules to interface with modules external to the SCM. The harness is often secured to the non-interface (rear) side of the external receptacle before the SCM is lowered into the sea. Other independently retrievable units similar to the SCM exist, with different sub-modules and functions. One such module is the power and communication distribution module (PCDM).

Conventionally, the fastening mechanism on the end of the harness which is often secured to the rear of the external receptacle may include the cable termination into individual cable cores and a solder bucket. The solder bucket provides electrical conductivity for the connection and helps prevent the cable cores from becoming dislodged. This approach is straightforward to manufacture, compatible with many designs of harness and can be changed later as required.

Some parts of a subsea distribution system (SDS) are sometimes assembled before they are deployed into position below sea level whilst other parts of the SDS may be added into the system after initial deployment. Components of the SDS, such as the subsea control module, are typically assembled on land, transported to the sea, and lowered to the desired subsea location. During the assembly process of an SCM, the sub-modules are sometimes installed, followed by the harnesses, which typically connect the sub-modules to the rear side of the external receptacles.

The harnesses can sometimes be subjected to mechanical loading during assembly, test and movement from manufacturing base to in-country/offshore and finally subsea. Mechanical fatigue of the solder joint or directly behind said joint has been noted as a design flaw within conventional harnesses utilised in subsea applications (or that may be supplied into the subsea market by third parties). The consequences and cost of repair can be significant. Aptly the consequences and cost of repair throughout the lifecycle of the subsea module can be significant.

A solution proposed to this problem is to overmould the back-end around the solder buckets of connectors which are at a risk of failing, or where the consequence of failure is high, to attempt to reinforce the connector region with a polymer. This solution is not ideal as the final results are typically variable, often increasing time to manufacture, cost and preventing onsite rework/repair, as the whole overmould polymer would need to be removed by the equipment manufacturer.

Another solution that has been proposed to prevent harness failure is to remove the load being applied to the solder bucket termination. This approach can sometimes involve soldering (or the like) the individual cable cores of the harness to the solder buckets. However, this can add complexity and can have a consequence of typically increasing the manufacturing and build time of the SCM.

There is a need for a simple, cost-effective to the problem of harness failure in subsea modules such as SCMs, preferably having compatibility with existing harness solutions.

It is an aim of the present invention to at least partly mitigate one or more of the above-mentioned problems.

It is an aim of certain embodiments of the present invention to provide apparatus for connecting an elongate transmitting element (such as a wire or a core of a cable or the like) to a transmitting connector (such as a wet-mate or dry-mate connecter of a subsea module) via an intermediate transmitting connector (such as a solder bucket and/or solder cup or the like).

It is an aim of certain embodiments of the present invention to provide a method of connecting an elongate transmitting element (such as a wire or a core of a cable or the like) to a transmitting connector (such as a wet-mate or dry-mate connecter of a subsea module) via an intermediate transmitting connector (such as a solder bucket and/or solder cup or the like).

It is an aim of certain embodiments of the present invention to provide a cost effective and robust connection between at least one wire core of a wire harness and a wet-mate and/or dry-mate connector via at least one solder bucket.

It is an aim of certain embodiments of the present invention to provide apparatus for connecting one or more wire harnesses to a wet-mate and/or dry-mate connector, optionally associated with a subsea control module (SCM) or power and communication module (PCDM). Aptly the SCM or PCDM are examples of a subsea modules. Optionally any other suitable subsea module may instead be utilised.

It is an aim of certain embodiments of the present invention to provide a method for connecting at least one core of a wire harness to a wet-mate and/or dry mate connector via at least one solder bucket in a robust and cost-effective manner. Aptly other suitable connection methods may be utilised instead of solder buckets.

It is an aim of certain embodiments of the present invention to permit fluid communication into, and out of a chamber associated with a region in which at least one core of a wire harness is connected to a connection interface (for example a wet-mate and/or dry-mate connector) via at least one solder bucket. Aptly other suitable connection methods may be utilised instead of solder buckets.

It is an aim of certain embodiments of the present invention to provide apparatus which is resistant to connection failure between a wire core of a wire harness and a solder bucket.

It is an aim of certain embodiments of the present invention to provide apparatus which allows connection of multiple wire cores of a wire harness to respective solder buckets associated with a subsea control module, the wire harness optionally being an umbilical. Aptly the subsea control module is an example of a subsea module. Optionally any other suitable subsea module may instead be utilised.

It is an aim of certain embodiments of the present invention to secure a harness arrangement (that includes a cable including one or more conducting wires/cores) to a housing of a module (that optionally is a subsea module) via a cable gland.

According to a first aspect of the present invention there is provided apparatus for connecting at least one elongate transmitting element to a transmitting connector via at least one intermediate transmitting element, comprising:
a transmitting connector locatable at an outer surface of a housing that defines a chamber:
at least one elongate transmitting element locatable at least partly within the housing; at least one intermediate transmitting element associated with the transmitting connector and couplable to the elongate transmitting element; and
a retaining element locatable within the housing and comprising a first retaining portion and a further retaining portion, the first retaining portion being for retaining the elongate transmitting element at a particular position with respect to the retaining element, and the further retaining portion being for engaging with a securing region associated with the housing; wherein
the retaining element is for retaining the elongate transmitting element at a predetermined position with respect to the housing.

Aptly the first retaining portion is for engaging with the elongate transmitting element.

Aptly the first retaining portion is for indirectly engaging with the elongate transmitting element.

Aptly the first retaining portion is indirectly engaged with the elongate transmitting element, one or more intermediary elements being interspaced between the first retaining portion and the elongate transmitting element, the intermediary element optionally being a sheath that optionally is a polymer sheath.

Aptly the apparatus further comprises at least one intermediary element interspaced between the first retaining portion and the elongate transmitting element, the intermediary element optionally being a sheath in which the elongate transmitting element is disposed.

Aptly the apparatus further comprises an adaptor wherein at least part of the adaptor is interspaced between the retaining element and the housing.

Aptly the adaptor is locatable through a first aperture provided in the housing or is securable to an inner surface of the housing.

Aptly the adaptor comprises a locating portion at a first end of the adaptor that is securable to the housing or is locatable between the housing and the transmitting connector.

Aptly the adaptor at least partly surrounds or defines a further chamber.

Aptly the intermediate transmitting element is locatable within the further chamber and the elongate transmitting element can be terminated at and is connectable to the intermediate transmitting element.

Aptly the apparatus further comprises at least one further aperture through a wall of the adaptor that is for permitting fluid communication between a first region that is located within the housing but external to the adaptor and a further region that is located within the housing and within the adaptor.

Aptly the further region is located within the further chamber.

Aptly the adaptor comprises the securing region.

Aptly the securing region comprises a threaded through hole.

Aptly the housing is an external housing of a subsea module for example a subsea control module, or a power and communications distribution module, or a power distribution and protection module, or a subsea electronics module or a downhole interface module.

Aptly the housing is an external housing of a subsea module for example a downhole interface unit.

Aptly the transmitting connector is a wet mate connector.

Aptly the intermediate transmitting element is a solder bucket or a solder cup.

Aptly the housing is filled with a fluid that optionally is a dielectric oil. Aptly the housing may be filled with any other suitable fluid.

Aptly the transmitting connector comprises a plurality of connection elements.

According to a second aspect of the present invention there is provided a method of connecting at least one transmitting element to a transmitting connector via at least one intermediate transmitting element, comprising the steps of:
providing at least one elongate transmitting element at least partly within a housing;
coupling the elongate transmitting element to at least one intermediate transmitting element associated with a transmitting connector that is at an outer surface of the housing;
retaining the elongate transmitting element at a particular position with respect to a retaining element via a first retaining portion of the retaining element; and
engaging a further retaining portion of the retaining element with a securing region that is associated with the housing to thereby retain the elongate transmitting element at a predetermined position with respect to the housing.

Aptly the method further comprises securing an adaptor that comprises the securing region to an inner surface of the housing or between the housing and the transmitting connector, the intermediate transmitting elements being located within the adaptor thereby locating the elongate transmitting connector at least partly within the adaptor.

Aptly engaging the further retaining portion with the securing region comprises rotating a threaded mating outer surface region of the further retaining portion with respect to a threaded mating inner surface region of the securing region to thereby secure the further retaining portion to the securing region.

Aptly retaining the elongate transmitting element at a particular position with respect to the retaining element comprises locating the elongate transmitting element through a bore/central passageway of the retaining element.

Aptly retaining the elongate transmitting element at a particular position with respect to the retaining element comprises rotating the first retaining portion with respect to the further retaining portion to urge a tapered inner surface region of the first retaining portion into abutment with a compressing portion, that optionally is a resilient portion, of the retaining element thereby urging the compressing portion radially inwardly.

Aptly the method further comprises engaging the further retaining portion of the retaining element with the securing region prior to, during or subsequent to retaining the elongate transmitting element at a particular position with respect to the retaining element.

According to a third aspect of the present invention there is provided a system, comprising:
a subsea module comprising a housing;
at least one transmitting connector located at an outer surface of the housing;
at least one intermediate transmitting element associated with the transmitting connector;
at least one elongate transmitting element disposed within the housing and connected to the intermediate transmitting element; and
a retaining element comprising a first retaining portion that retains the elongate transmitting element at a particular position with respect to the retaining element, and a further retaining portion that is engaged with a securing region associated with the housing; wherein
the retaining element retains the elongate transmitting element at a predetermined position with respect to the housing.

Aptly the intermediate transmitting element is disposed within the housing.

Aptly the intermediate transmitting element is disposed at a rear surface of the transmitting connector.

Aptly the system further comprises an adaptor disposed between the securing element and the transmitting connector.

Aptly the system further comprises an inner chamber located within the adaptor through which at least part of a length of the elongate transmitting element extends.

Aptly the system further comprises at least one aperture located through a wall of the adaptor for permitting fluid communication between a first fluid communication region disposed in the inner chamber and a further fluid communication region that is located within the housing but outside of the adaptor.

Aptly the adaptor comprises the securing region.

Aptly the securing region is located at a terminal end region of the adaptor and comprises a threaded aperture in a wall of the adaptor.

According to a fourth aspect of the present invention there is provided apparatus for securing at least one element at a rigid housing of a subsea module, comprising;
a flexible elongate element comprising an outer sheath having a cylindrical outer surface;
a first retaining member secured with respect to a wall member of a housing of a subsea module, that includes an inner surface comprising a frustoconical surface region;
an annular sealing member threaded over the outer sheath and disposed within and coaxial with the first retaining member; and
a further retaining member securable to the first retaining member to deform the annular sealing member between the frustoconical surface and the outer sheath.

Aptly, the wall member of a housing comprises a portion of a housing of a subsea control module (SCM) or a subsea power and control distribution module (PCDM). Aptly the PCDM is an example of a subsea module. Optionally any other suitable subsea module may instead be utilised.

Aptly, the first retaining member is secured to a blank body, comprising a screw threaded through hole, that is secured to an inner surface of the wall member.

Aptly, the first retaining member is secured to a screw threaded through hole in the wall member.

Aptly, the apparatus further comprises an interface member that comprises a flange secured to the wall member, a cylindrical body that extends from the flange away from a through hole in the flange, and that optionally includes one or more through holes through the cylindrical body, and an end cap that at least partially closes an end of the cylindrical body at a cylinder body end region distal to the flange; wherein a screw threaded through hole in the end cap has a screw threaded region that cooperates with a mating screw threaded region of the first retaining member.

Aptly, the flange is disposed on an inner surface of the housing wall member or on an outer surface of the housing wall member.

Aptly, oil or other electrically insulating fluid is disposed in a chamber region defined within the cylindrical body, and optionally the oil or other electrically insulating fluid is at a positive or equal pressure with respect to a surrounding pressure of sea water that surrounds the subsea module.

Aptly, screw threaded through holes are through holes having a radially inwards facing surface that includes a screw thread.

Aptly, respective screw threads of the first retaining member and a through hole mate and optionally are straight threads or tapered threads.

Aptly, the flexible element comprises a cable or umbilical.

Aptly, the cable comprises at least one electrically conductive flexible power conductor.

Aptly, the umbilical comprises a plurality of flexible data conductors and/or power conductors.

Aptly, the cable comprises a wire and/or a wire ethernet link and/or power wire and/or fibre wire and/or signal wire and/or a multistranded wire and/or a single core wire and/or a multi-core wire.

Aptly, the outer sheath is terminated short of respective ends of one or more power wires and/or data wires in the flexible element to reveal terminating end regions of each power wires and/or data wire.

Aptly, the terminating ends regions are soldered to respective electrodes on respective mating connectors on the housing.

Aptly, the first retaining member and the further retaining member and the annular sealing member together comprise a mechanical cable entry device that is optionally a sealing gland.

Aptly, the first retaining member comprises an inner seal assembly element and the further retaining member comprises an outer seal assembly element and the annular sealing member comprises a clamping ring.

According to a fifth aspect of the present invention there is provided apparatus for connecting at least one elongate transmitting element to a transmitting connector via at least one intermediate transmitting element, comprising:
a transmitting connector at an outer surface of a housing that defines a chamber;
at least one elongate transmitting element located at least partly within the housing;
at least one intermediate transmitting element associated with the transmitting connector and coupled to the elongate transmitting element; and
a retaining element disposed within the housing and comprising a first retaining portion and a further retaining portion, the first retaining portion being engaged with the elongate transmitting element, the further retaining element being engaged with a securing region associated with the housing; wherein
the retaining element retains the elongate transmitting element at a predetermined position with respect to the housing.

Aptly, the first retaining portion is indirectly engaged with the elongate transmitting element, one or more intermediary elements being interspaced between the first retaining portion and the elongate transmitting element, the intermediary element optionally being a sheath that optionally is a polymer sheath.

Aptly, the first retaining portion being engaged with the elongate transmitting element comprises the first retaining portion providing a retaining force that retains a portion of the elongate transmitting element, that optionally is disposed radially within the retaining element, at a position with respect to the retaining element.

Aptly, the first retaining portion clamps on an outer surface at least one of the intermediary elements or the elongate transmitting element.

Aptly, the transmitting connector is a wet-mate connector.

Aptly, the housing is an outer cover for a subsea control module.

Aptly, the elongate transmitting element is a core of a cable, the cable optionally being an umbilical.

Aptly, the elongate transmitting element is disposed in a sheath.

Aptly, the elongate transmitting element is part of a wire harness.

Aptly, a plurality of elongate transmitting elements are disposed in a sheath that optionally is an outer sheath, and optionally the plurality of elongate transmitting elements form part of a harness (that optionally is a wire harness).

Aptly, the intermediate transmitting element is a solder bucket/solder cup.

Aptly, the intermediate transmitting element is disposed within the transmitting connector.

Aptly, the intermediate transmitting element is disposed within the housing.

Aptly, the transmitting connector is a wet-mate connector and/or a dry-mate connector.

Aptly the transmitting connector is an interface for connection with a further interface that cooperates and/or mates with the interface.

Aptly, the housing is an external housing of a subsea control module (SCM)

Aptly, the housing is an external housing of a power distribution and protection module (PPDM) or a PCDM.

Aptly the housing is an external housing of a module that is disposed within a SCM or a PCDM, the housing optionally being a subsea electronics module (SEM) housing or the like.

Aptly, the elongate transmitting element is a power transmitting conduit that comprises a metallic material that optionally includes copper.

Aptly, the elongate transmitting element is a signal transmitting element.

Aptly, the elongate transmitting element comprises a fibreoptic conduit.

Aptly, the intermediate transmitting element comprises a solder bucket, the solder bucket optionally further comprising a recess in which a terminal end of the elongate transmitting element is locatable.

Aptly, the elongate transmitting element and the intermediate transmitting element are coupled by soldering.

Aptly, the apparatus further comprises an adaptor interspaced between the retaining element and the housing.

Aptly the adaptor comprises the securing region, the retaining element being engaged with the adaptor, and the adaptor is secured to the housing.

Aptly, the adaptor defines a chamber.

Aptly, the intermediate transmitting element is disposed within the chamber, and the elongate transmitting element is terminated at, and connected to, the intermediate transmitting element.

Aptly the chamber is at least partly flooded with fluid, the fluid optionally including an oil, the oil optionally including a dielectric oil.

Aptly the apparatus further comprises a fluid communication element, optionally disposed between the transmitting connector and the housing, the fluid communication element comprising at least one aperture through a wall of the fluid communication element that permit fluid communication between a first region that is located within the housing but external to the adaptor, and a further region that is located within the housing and within the adaptor, the further region optionally being a chamber of the adaptor.

Aptly, the fluid communication element is located between a flange portion of the adaptor and the transmission connector.

Aptly, the retaining element is a cable gland.

Aptly, the retaining element comprises in inner body and an outer body, the outer body optionally comprising a substantially conical portion.

Aptly the inner body and the outer body are at least partly rotatable relative to each other.

Aptly the inner body comprises a first threaded portion located on an outer surface of the inner body, and the outer body comprises a further threaded portion located on an inner surface of the outer body, the inner body and the outer body being configured to engage via the first threaded portion and further threaded potion.

According to a sixth aspect of the present invention there is provided a method of connecting at least one elongate transmitting element to a transmitting connector via at least one intermediate transmitting element, comprising:
providing at least one elongate transmitting element at least partly within a housing;
coupling the elongate transmitting element to at least one intermediate transmitting element associated with a transmitting connector that is at an outer surface of the housing;
engaging a first retaining portion of a retaining element with the elongate transmitting element and engaging a further retaining portion of the retaining element with a securing region that is associated with the housing.

According to a seventh aspect of the present invention there is provided apparatus for connecting at least one elongate core element of a cable to a wet-mate connector of a subsea control module via at least one solder bucket, comprising:
a wet-mate connector at an outer surface of a subsea control module housing;
a cable at least partly located within the housing and comprising at least one elongate core element;
at least one solder bucket associated with the wet-mate connector and coupled to a terminal end of the elongate core element;
a cable gland arranged at least partly within the housing and radially surrounding a portion of the cable, the cable gland comprising a through hole through which the cable extends; wherein
an inner securing region of a portion of through hole is engaged with an outer surface of the cable and an outer securing region of the sealing gland is engaged with a further securing region that is associated with the housing to retain the cable at a predetermined position with respect to the housing.

According to an eighth aspect of the present invention there is provided use of a cable gland to simultaneously locate and seal a respective end region of a cable interconnecting a submodule within a subsea module to a respective wet mate connector on an outer surface of the subsea module.

Aptly, the subsea module is an SCM or PCDM or a downhole interface unit (DUI).

Aptly, the submodule is an SEM or valve unit or accumulator unit or an interface unit or an actuator unit.

Aptly, the cable gland restricts respective movement of a solder joint between each core in the cable and a respective connector element thereby reducing risk of a solder failure.

Aptly, one or more cable glands can be individually secured to a region proximate to a two-way or four-way or seven-way eight-way or twelve-way sixteen-way or twenty-four-way wet mate connector disposed at an outer surface of the subsea module housing. Cores from each cable secured by each respective cable gland can be lead through to be soldered or otherwise electrically connected a respective connector that leads to a respective electrode of a wet mate connector. The electrode may be a male or female terminal.

Aptly, one or more cable glands can be individually secured to a region proximate to a wet-mate and/or a dry mate connector disposed at an outer surface of the subsea module housing. Cores from each cable secured by each respective cable gland can be lead through to be soldered or otherwise electrically connected a respective connector that leads to a respective electrode of a wet mate connector. The electrode may be a male or female terminal.

Aptly, a T-shaped or Y-shaped or L-shaped intermediate body is disposed inside the subsea module housing proximate to a wet mate connector and each intermediate body has a screw thread at an end region of the intermediate body to receive a mating screw thread of a cable gland carrying a respective cable.

According to a nineth aspect of the present invention there is provided apparatus for connecting at least one elongate transmitting element to a transmitting connector via at least one intermediate transmitting element, comprising:
a transmitting connector at an outer surface of a housing that defines a chamber;
at least one elongate transmitting element located at least partly within the housing;
at least one intermediate transmitting element associated with the transmitting connector and coupled to the elongate transmitting element; and
a retaining element disposed within the housing and comprising a first retaining portion and a further retaining portion, the first retaining portion retaining the elongate transmitting element at a particular position with respect to the retaining element, the further retaining element being engaged with a securing region associated with the housing; wherein
the retaining element retains the elongate transmitting element at a predetermined position with respect to the housing.

According to a tenth aspect of the present invention there is provided a method of connecting at least one elongate transmitting element to a transmitting connector via at least one intermediate transmitting element, comprising the steps of:
coupling at least one elongate transmitting element to a respective intermediate transmitting element associated with a transmitting connector;
locating the elongate transmitting element at least partly through an aperture in a wall of a housing so that the elongate transmitting element is located at least partly within the housing and the transmitting connector is located at an outer surface of the housing;
retaining the elongate transmitting element at a particular position with respect to a retaining element via a first retaining portion of the retaining element; and
engaging a further retaining portion of the retaining element with a securing region that is associated with the housing to thereby retain the elongate transmitting element at a predetermined position with respect to the housing.

Aptly the method further comprises engaging the further retaining portion of the retaining element with the securing region prior to, during or subsequent to retaining the elongate transmitting element at a particular position with respect to the retaining element.

Aptly the method further comprises, prior to locating the elongate transmitting element at least partly through the aperture, providing an adaptor radially around at least a portion of the elongate transmitting element.

Aptly locating the elongate transmitting element at least partly through an aperture in a wall of a housing comprises locating the adaptor between the housing and the transmitting connector.

Aptly locating the elongate transmitting element at least partly through an aperture in a wall of a housing comprises locating at least a portion of the adaptor through the aperture thereby locating at least a portion of the adaptor within the housing.

Aptly the method further comprises securing the transmitting connector to the housing via at least one of securing element.

Certain embodiments of the present invention provide robust and cost-effective connection between an interface (for example, a wet-mate and/or dry-mate connection) and at least one wire core of a wire harness via at least one solder bucket.

Certain embodiments of the present invention provide a cable gland that secures around an outer surface of the harness (that is to say around the outer sheath of the cable) and also secures (for example via respective cooperating threaded interfaces or surfaces) to a securing region associated with the housing. An adaptor or bracket may be located between the cable gland and the housing (or a wall of the housing) and the adaptor (which may be secured to the housing) may include the securing region. The wires of the harness may each terminated at solder buckets located within the housing (and optionally within the adaptor) that are associated with a wet mate connector located at an outer surface of the housing or to a dry mate connector that is couplable to a dry mate rear interface of a wet mate connector. The wires of the harnesses may instead each be terminated at solder buckets located at a rear end region of the wet mate connector.

Certain embodiments of the present invention provide apparatus for connecting an interface (for example, a wet-mate and/or dry-mate connection) and at least one wire core of a wire harness via at least one solder bucket which limits the flexibility of the wire harness at a region near the connection between the cores and solder buckets.

Certain embodiments of the present invention provide a method for connecting an interface (for example, a wet-mate and/or dry-mate connection) and at least one wire core of a wire harness via at least one solder bucket which limits the flexibility of the wire harness at a region near the connection between the cores and solder buckets.

Certain embodiments of the present invention provide reduced failure of a connection between a wire core of a wire harness and a solder bucket associated with an interface (for example a wet-mate and/or dry mate connector) due to breaking which may occur due to aberrant flexing and/or movement of the harness.

Certain embodiments of the present invention provide a reduced pressure differential at a connecting region (between an interface (which may be a wet-mate and/or dry mate connector) and a harness) and a region enclosed by a housing on which the connecting region in arranged, when the inner region is at least partly filled with fluid. The fluid may be oil, for example dielectric oil. The inner region may be a region of a subsea control module SCM and/or a power distribution and protection module (PDPM) and/or a power and communication distribution module (PCDM).

Certain embodiments provide an electrical connector solution for all internal harnessing within an SCM or PCDM or other such subsea module. This helps reduce a need to over mould the backend of connectors that care conventionally used and that currently have a high COPQ cost.

Certain embodiments of the present invention help address—

Removes all mechanical load on the solder bucket that are being introduced by:
1. mechanical handling
2. dynamic loading of the SCM/PCDM covers going up and down
3. vibration during transit
4. extensive rework time delay due to a fault and high COPQ cost

Certain embodiments of the present invention reduce mechanical load applied to a solder bucket due to mechanical handling and/or dynamic loading of a cover/housing of a SCM being moved up and down relative to the solder bucket and/or dynamic loading of a cover/housing of a PCDM being moved up and down relative to the solder bucket and/or dynamic loading of a cover/housing of a subsea module being moved up and down relative to the solder bucket and/or vibration during transit of a module including the solder bucket and/or extensive rework time delay due to fault and high cost of poor quality (COPQ). Optionally other connection elements may be utilised instead of solder buckets.

Certain embodiments of the present invention use existing industrial cable glands to provide mechanical restraint of the harness hose, that would then require a bracket to secure the cable gland to the electrical connector. This allows free flooding of the harness cores with dielectric oil and provide complete support of the harness removing any chance of failure. This helps provide a cheap and effective assembly solution that can allow for significantly reduced lead time, flexibility with different suppliers and overall cost reduction to the SCM and PCDM. Aptly the SCM or PCDM is an example of a subsea module. Optionally any other suitable subsea module may instead be utilised.

Certain embodiments of the present invention are completely backward compatible and improve the overall reliability of SCMs and PCDMs.

Certain embodiments of the present invention use a mechanical solution to bundle each dedicated harness to the associated electrical connector and then handle them as a full assembly. Far quicker, simpler and cost-effective solution.

Embodiments of the present invention will now be described hereinafter, by way of example only, with reference to the accompanying drawings in which:

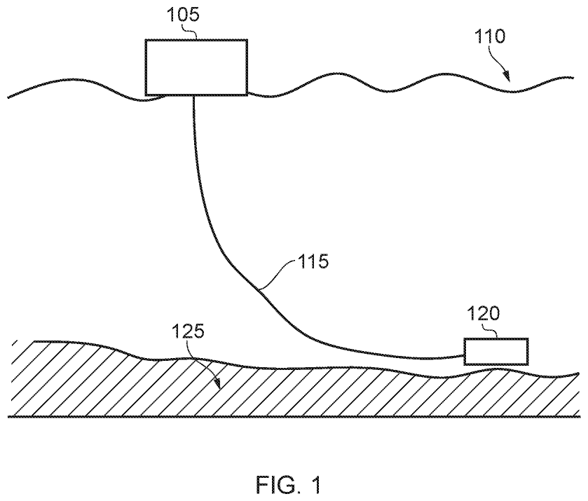

FIG. 1 illustrates a subsea electrical system;

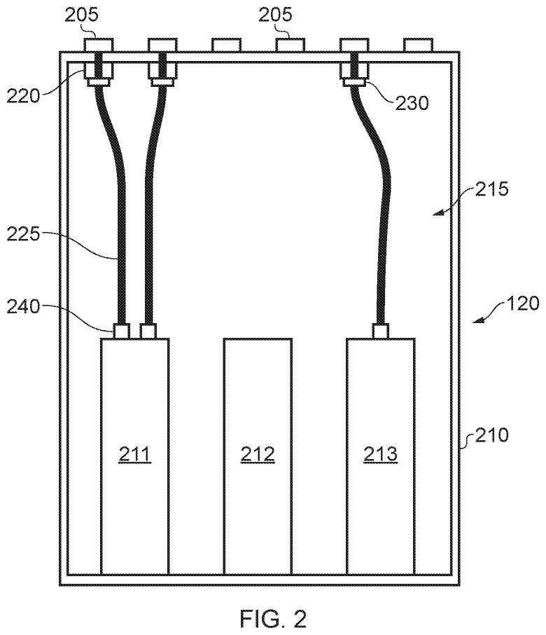

FIG. 2 illustrates a subsea control module;

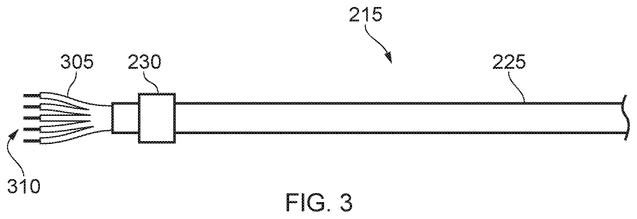

FIG. 3 illustrates a harness;

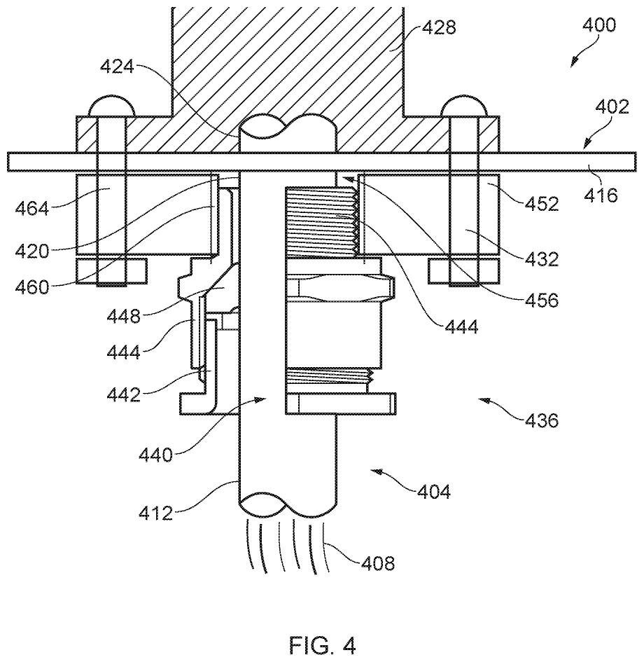

FIG. 4 illustrates a perspective view of a harness connection assembly for connecting a wire harness to a wet-mate interface;

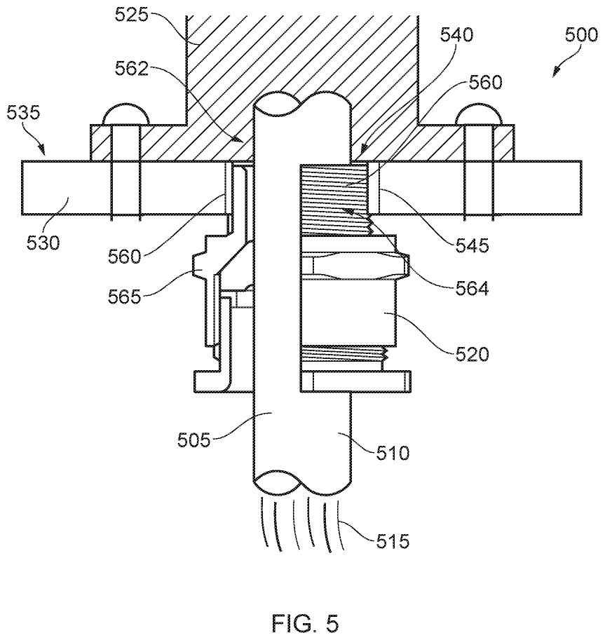

FIG. 5 illustrates a perspective view of a further harness connection assembly for connecting a wire harness to a wet-mate interface;

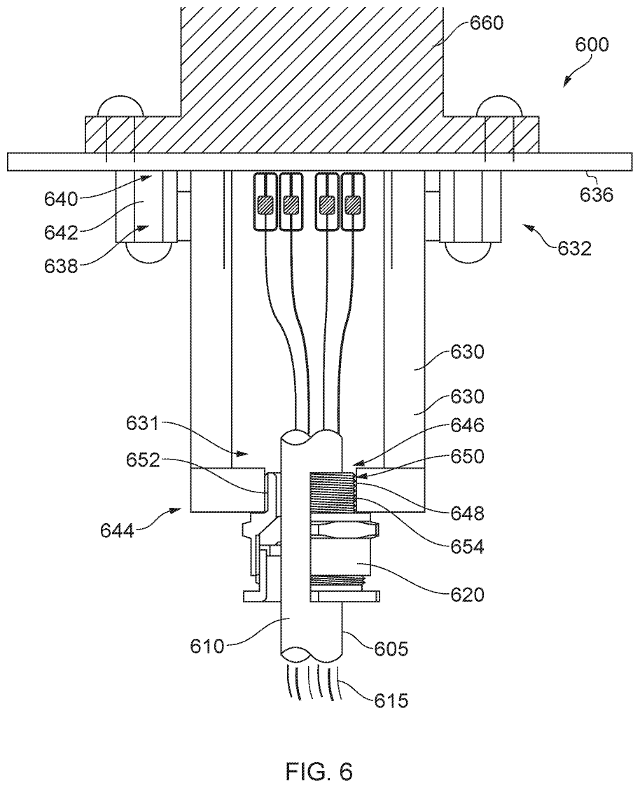

FIG. 6 illustrates a perspective view of a still further harness connection assembly for connecting a wire harness to a wet-mate interface;

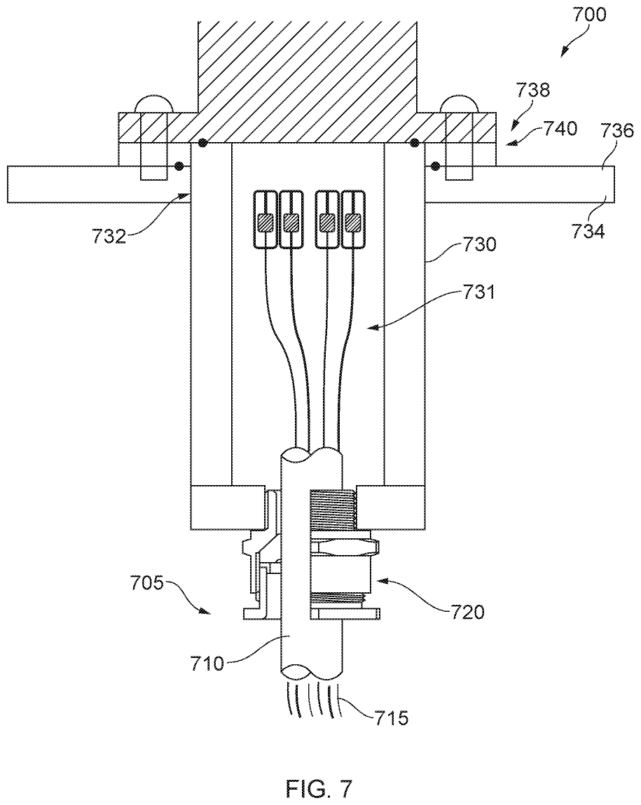

FIG. 7 illustrates a perspective view of still another harness connection assembly for connecting a wire harness to a wet-mate interface;

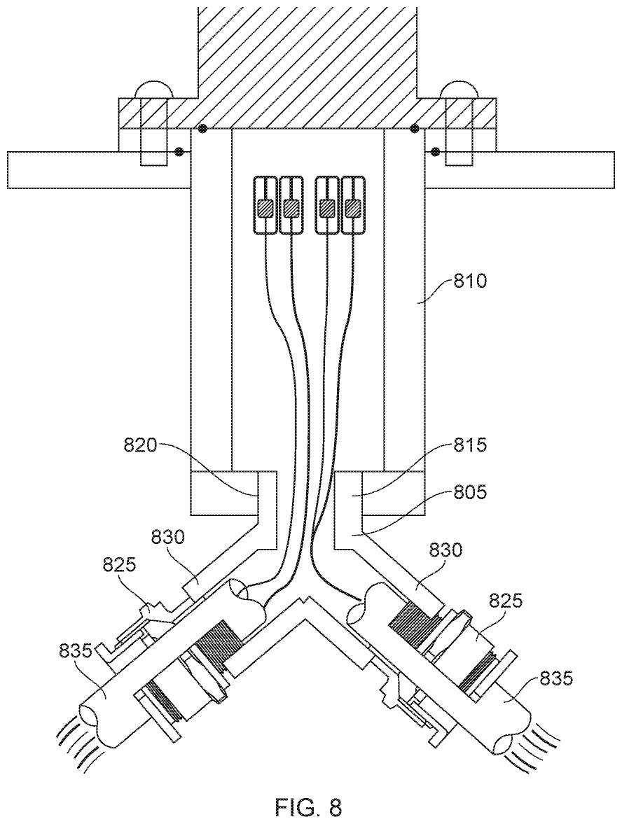

FIG. 8 illustrates a perspective view of yet another harness connection assembly for connecting two wire harnesses to a wet-mate interface;

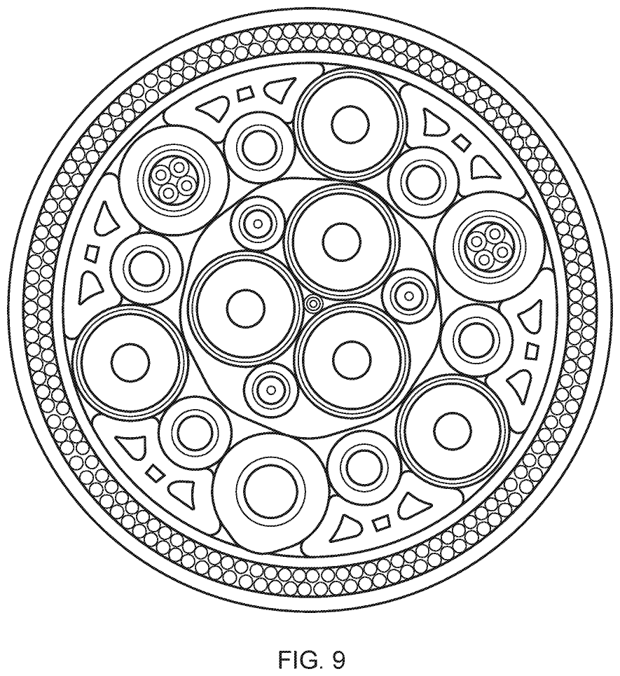

FIG. 9 illustrates an umbilical cable;

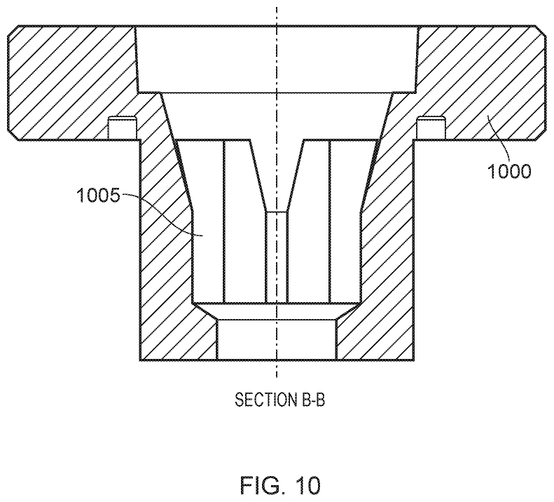

FIG. 10 illustrates a section view of a bracket;

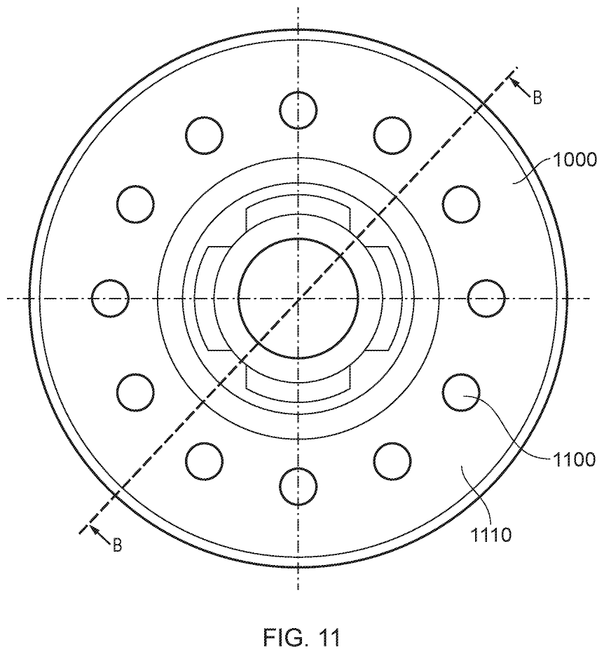

FIG. 11 illustrates a top view of a bracket;

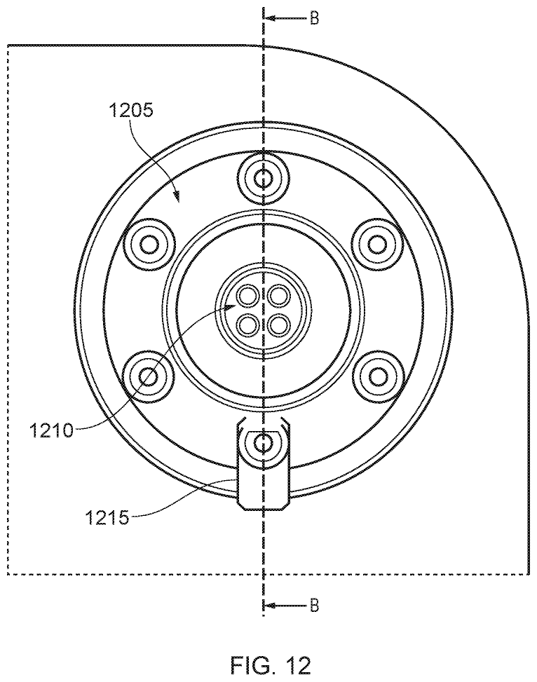

FIG. 12 illustrates a top view of a wet-mate interface for a 4-way connector;

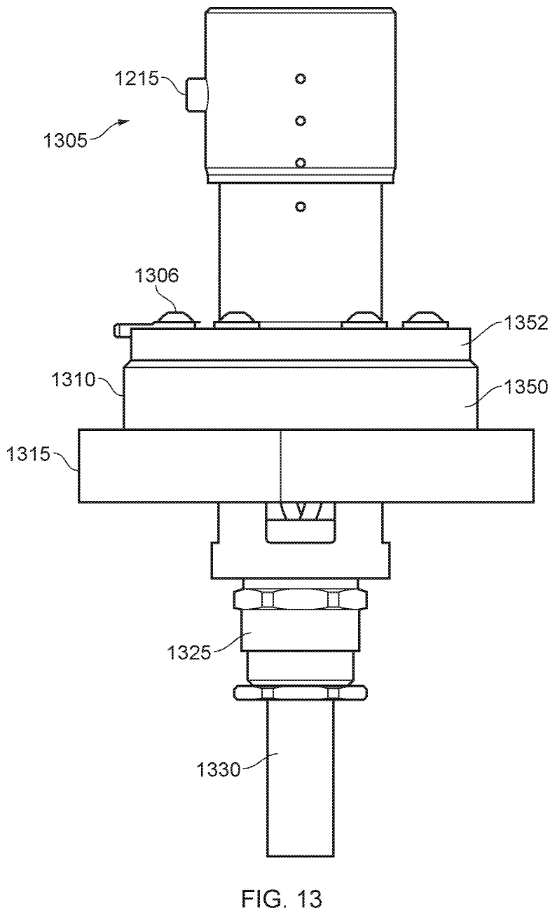

FIG. 13 illustrates a side view of a wet-mate interface for a 4-way connector with a harness;

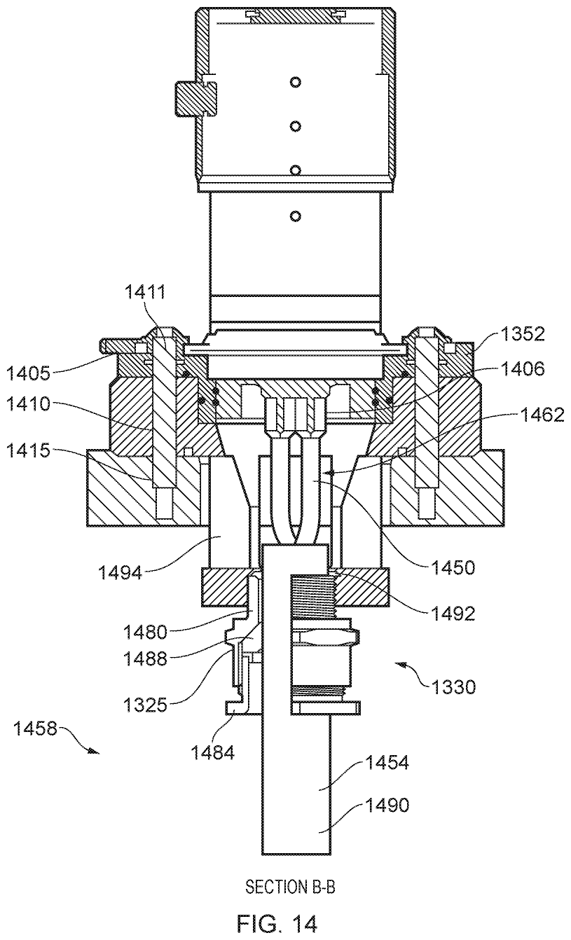

FIG. 14 illustrates a section view of a wet-mate interface for a 4-way connector with a harness;

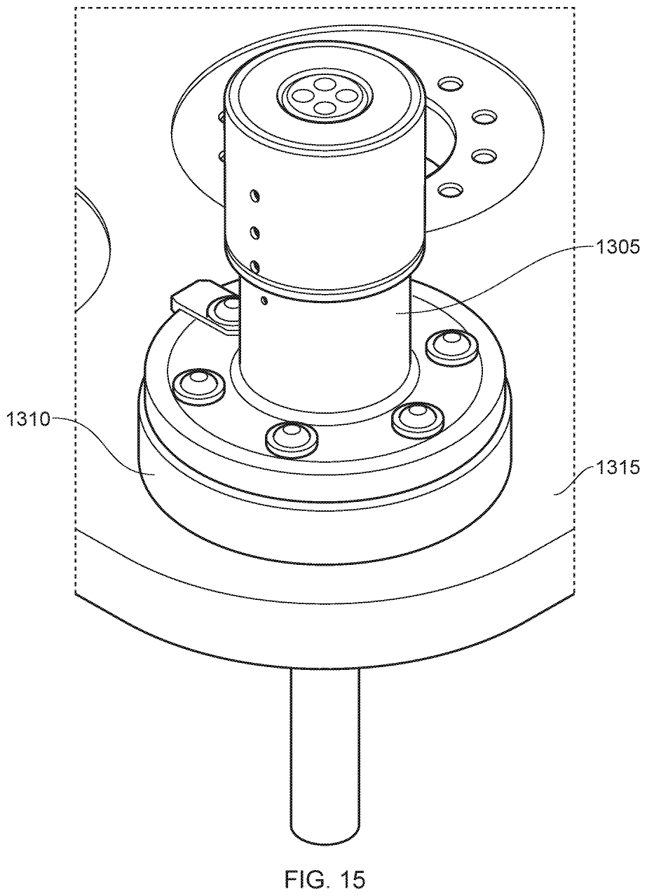

FIG. 15 illustrates an isometric view of a wet-mate interface for a 4-way connector with a harness;

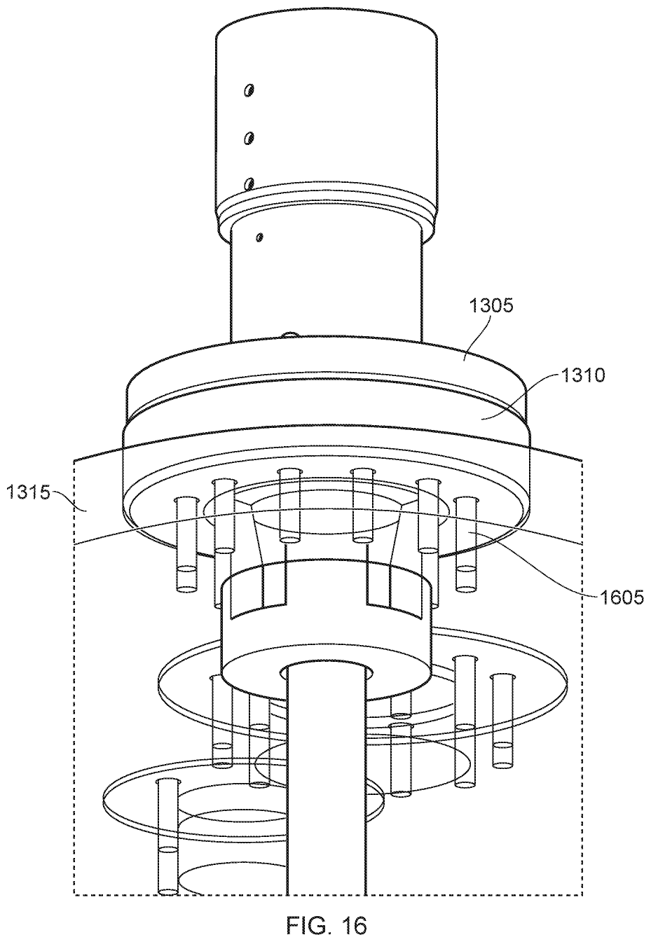

FIG. 16 illustrates different partially transparent isometric view of a wet-mate interface for a 4-way connector with a harness;

FIG. 17 illustrates a top view of a wet-mate interface for a 12-way connector;

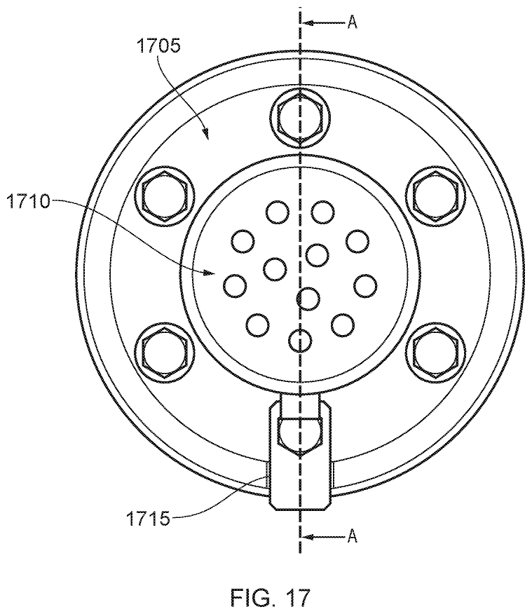

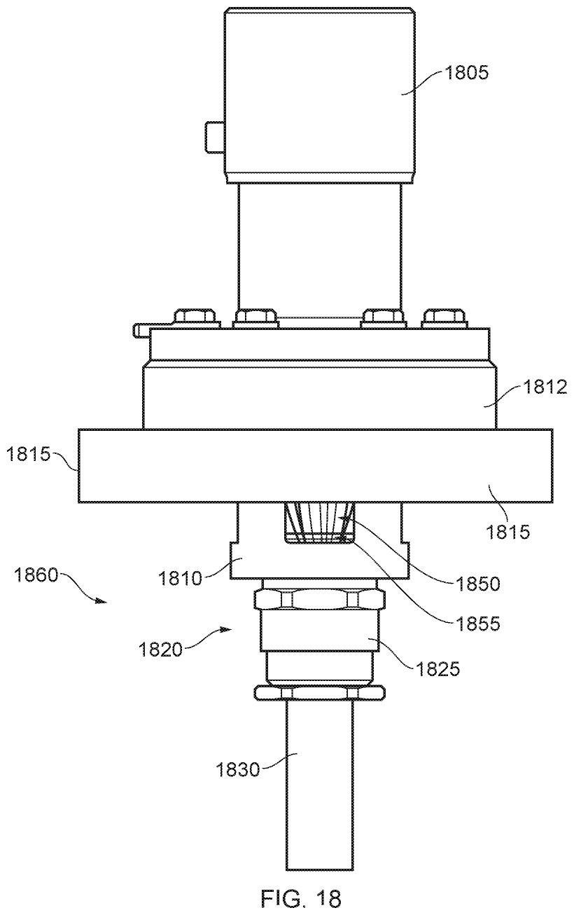

FIG. 18 illustrates a side view of a wet-mate interface for a 12-way connector with a harness;

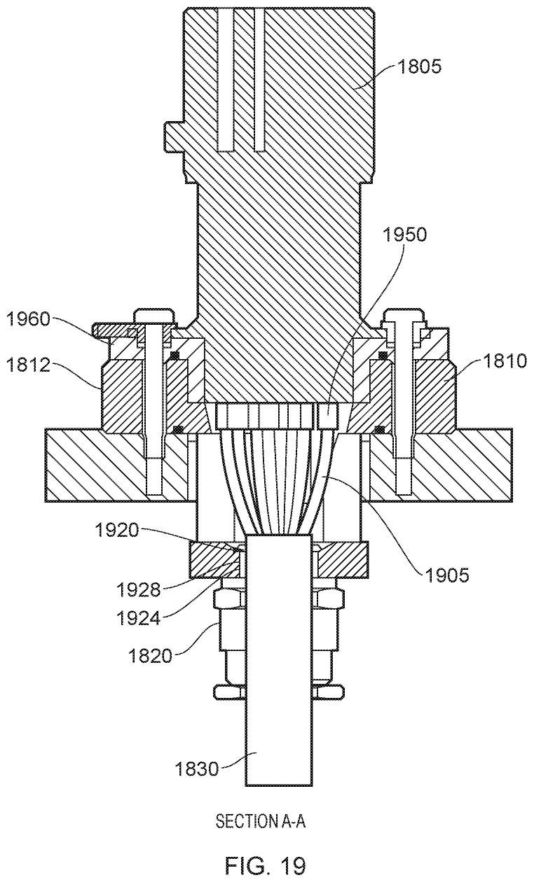

FIG. 19 illustrates a section view of a wet-mate interface for a 12-way connector with a harness;

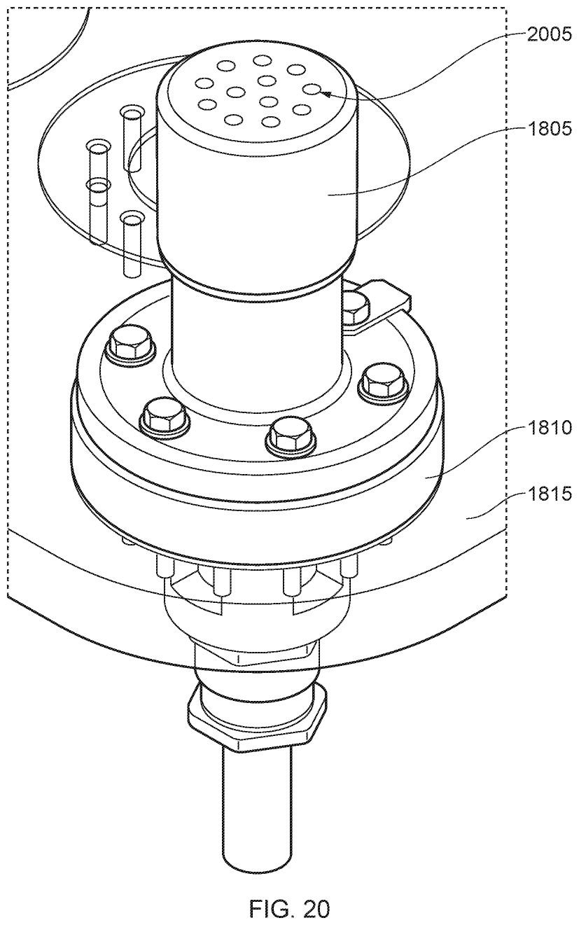

FIG. 20 illustrates an isometric view of a wet-mate interface for a 12-way connector with a harness; and

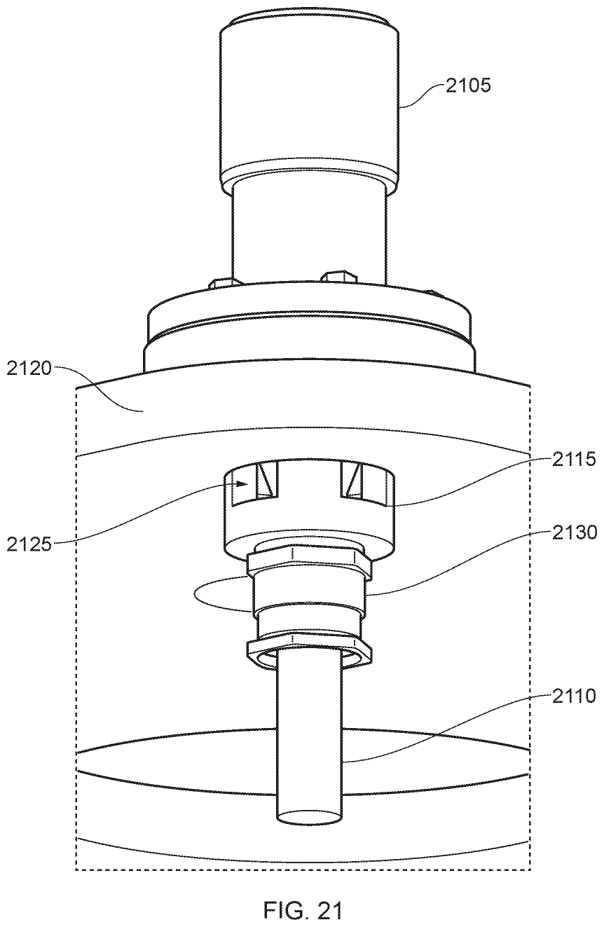

FIG. 21 illustrates different partially transparent isometric view of a wet-mate interface for a 12-way connector with a harness.

In the drawings like reference numerals refer to like parts.

FIG. 1 illustrates a subsea electrical system. The subsea system includes a surface facility 105 which is located at sea level 110 in an offshore location, an umbilical cable 115 which terminates on one end at the surface facility 105, and a subsea control module (SCM) 120, where the umbilical cable terminates on the other end. Optionally the SCM may instead be a power and communications distribution module (PCDM) or a subsea distribution unit which may include a PCDM or SCM or the like or any other subsea unit or module. The surface facility may be a floating facility such as an FPSO. The surface facility 105 contains the topside control equipment and the umbilical termination assembly (not shown). The surface facility 105 sends electrical power, hydraulic power, and communication signals along the umbilical cable 115 to the SCM. The umbilical cable 115 shown in FIG. 1 is unsupported and hangs under its own self-weight. The SCM is located near the seabed 125.

FIG. 2 illustrates a subsea control module (SCM) 120. It will be appreciated that other modules exist in the subsea electrical system which have a similar arrangement, for example a power and communication distribution module (PCDM). The SCM 120 illustrated in FIG. 2 is a schematic/simplification view of an SCM. The SCM 120 is cuboidal in shape and includes of number of protruding circular external interfaces 205. These interfaces may be located at different depths into the page. The SCM has an outer wall 210 which provides a housing for the internal components of the SCM. It will be appreciated that in some embodiments, the SCM has feet (not shown) which protrude from the bottom of the module. The SCM of FIG. 2 is filled with a dielectric oil (not shown) which prevents the outer housing and the internals of the SCM from being crushed by the pressure subjected upon the SCM in subsea environments. The SCM contains three sub-modules 211, 212, 213. It will be appreciated that in other embodiments, the SCM may contain as few as one or more than three sub-modules. For example, the SCM may contain two sub-modules. Sub-module 211 is a subsea electrical module (SEM). Aptly the sub-module may be any other suitable form of sub-module. Sub-modules are self-contained units which may be broadly cylindrical in shape. The SEM 211 is able to interface with external components of the subsea electrical system through the external interfaces 205 in the SCM. The SEM 211 is connected to an external interface 205 through a harness 215. In FIG. 2, the SEM 211 is connected to multiple external interfaces 205 by multiple harnesses 215. A harness comprises a main body 225 containing multiple cores of cable (not shown) and a termination at each end. Near each end of the harness is a cable gland 230. The cable gland 230 is a ring-shaped object (or optionally may be generally annular) which is concentric to the main body 225 of the harness 215. The cable gland 230 is threaded on its outer circumference (or optionally at least part of its outer circumference). The cable gland is an example of a mechanical device for connecting.

The harness is shown in more detail in FIG. 3. One end of a harness terminates at SEM 211. The other end of a harness 215 terminates at an external interface 205. On the inside of the SCM wall 210 are a number of brackets 220. The brackets 220 are located such that they align with the external interfaces 205. The brackets 220 are secured to the inside of the outer wall 210 of the SCM. Optionally the brackets may instead be secured to any other part of the housing wall, for example a portion of a respective bracket may extend through an aperture in the housing wall and be secured to the outer surface of the housing wall for example via a flange portion of the bracket. The brackets 220 are cylindrical in shape and are threaded on their inner circumference. Optionally the brackets 220 are threaded on an inner circumference of a bracket aperture disposed through a wall of the bracket at a terminal end of the bracket. The brackets 220 provide a secure mount for the harness. The harness is secured in place by screwing the threaded cable gland 230 into the threaded bracket 220.

It will be appreciated that the bracket may be an example of an adaptor.

FIG. 3 illustrates a section of the harness 215. The harness 215 is cylindrical in shape and includes of the main body 225, the cable gland 230, and a termination at each end. One end 310 is shown in FIG. 3. The main body 225 contains a number of individual cable cores 305. One or more cores can be carried by any given cable. The individual cable cores 305 are comprised of a conductive material such that they are capable of transferring electrical signals. These cable cores are visible at the one end 310 shown in FIG. 3. The cable gland 230 of the harness 215 is a ring-shaped object which is concentric to the harness body 225. The cable gland 230 is threaded on its outer circumference. Aptly the cable gland is threaded on its outer circumference along only a portion of the length of the cable gland. The cable gland 230 provides a method of securing the harness 215 to a threaded inner circumference.

Optionally, the cable gland is a multi-part component and includes a first threaded body portion including a threaded outer surface (along at least a portion of the first threaded body portion) that is securable to the threaded inner circumference (for example of the bracket of FIG. 2), a further threaded body portion that is securable to the first threaded body portion (via cooperative threaded regions located on the radially inner surface of the first threaded body portion and the radially outer surface of the further threaded body portion) and a resilient body portion located inside a generally conical region of the first threaded body portion. Optionally, when the first and further body potion are secured together, the resilient body portion is urged radially inwards to secure around a cable disposed radially therein.

Optionally, the cable gland may be first secured to a threaded inner circumference (that is to say a threaded aperture or the like) that is associated with the housing of the SCM 120, for example, (for instance via the bracket 220) before the cable gland is secured around the cable (or main body 225) of the harness 215. This may help alleviate twisting of the cable/main body 225 when securing the cable/main body 225 to the bracket or SCM housing or the like. For example, a threaded radially outer surface of a first body portion of the cable gland may be secured to a threaded radially inner surface of a bracket or the like before a radially inner portion of the cable gland (such as a resilient portion) is secured around an outer surface of the main body 225 of the harness (for example via tightening a threaded connection between the first body portion and a further body portion of the cable gland).

FIG. 4 illustrates a harness connection assembly 400 of a subsea control module (SCM) 402. The harness connection assembly could of course be utilised in other suitable devices such as a power distribution and protection module (PDPM) or a power and communication distribution module (PCDM). It will be appreciated that the harness shown in FIG. 4 extends between an exterior connector of the SCM and an internal component of the SCM (not shown in FIG. 4) for example a subsea electronics module (SEM) housed within the SCM. The harness connection assembly 400 includes a harness 404. The harness of FIG. 4 includes multiple core elements 408 surrounded by a sheath 412. The core elements of FIG. 4 are power transmission lines however it will be appreciated that the cores may instead be other transmission elements. For example, the cores may be hydraulic lines and/or ethernet lines and/or fibreoptic lines and/or information carrying lines and/or signal carrying lines. The sheath of FIG. 4 is a polymer material however any other suitable material could instead be utilised. It will be appreciated that the harness of FIG. 4 includes a cable arrangement that is an umbilical. Optionally any other suitable harness arrangement may instead be utilised. The cable is a flexible elongate element that has a smooth generally cylindrical outer surface. The cores in each cable (there may be one or more cores) may themselves be elongate flexible elements. Alternatively, any other suitable cable arrangement may instead be utilised. The harness of FIG. 4 includes 6 cores however the skilled person would understand that any other number of cores may instead be utilised.

It will be appreciated that the cable may be armoured. It will be appreciated that the cable may not be armoured.

As illustrated in FIG. 4, most of the harness 404 is arranged within the SCM 402. That is to say that most of the harness is arranged within a housing 416 of the SCM. A terminal end of the harness 420 extends through an aperture 424 of the SCM housing and into a wet-mate connector that is arranged at an outer surface of the housing at the housing aperture 424. In the arrangement of FIG. 4, the wet-mate connector is secured to the SCM housing via elongate fasteners extending through respective securing through holes of the housing. Although not shown in FIG. 4, it will be appreciated that each of the cores of the harness extend into the wet mate connector and terminate at respective solder buckets/solder cups located in the wet-mate connector. The solder buckets are examples of intermediate transmitting elements. A harness may be wholly inside the housing of the subsea module or mostly inside as described immediately above.

The harness connection assembly of FIG. 4 further includes a cable gland 436. It will be appreciated that the cable gland is an example of a retaining element. The cable gland is arranged within the SCM housing and radially surrounds a portion of the cable. The cable gland of FIG. 4 is generally cylindrical in shape. It will be appreciated that any other suitable shape of cable gland could instead be utilised. The cable gland 436 includes a central bore/through hole 440 through which a portion of the cable extends. The cable gland of FIG. 4 is made from a metal material however it will be appreciated that the cable gland may include any suitable material. The parts of the cable gland are rigid apart from a sealing ring part which may be resilient. As shown in FIG. 4, the cable gland includes an inner body 442 and an outer body 444. The outer body and inner body of the cable gland are rotatable with respect to each other and are engaged via a first threaded portion on an inner surface of outer body and a further threaded portion on an outer surface of the inner body. The cable gland also includes a compressing element located at an interface between a terminal end of the inner body and a conical portion of the outer body.

It will be appreciated that rotation of the outer body relative to the inner body acts to reduce or increase the spacing distance between the conical portion of the outer body and the terminal end of the inner body that is most proximate to the conical portion of the outer body, depending on the direction of the rotation. This is due to the threaded connection between the inner and outer body. When the spacing distance between this terminal end of the inner body and the conical portion of the outer body is substantially reduced, it will be appreciated that due to the abutment between the conical portion of the outer body and a complementary slanted surface of the compressing element the compressing element is forced radially inwardly into the bore of the cable gland. Thus, when a cable is arranged in the bore of the cable gland, the compressing element is forced inwardly into biting engagement with an outer surface of the sheath of the cable. The compression element thus acts to clamp the cable such that the cable and the cable gland are not separately movable. That is to say that the cable is not movable with respect to the cable gland. The compression force provided by the compressing element on the cable also acts to clamp the cores of the cable such that the cores are not movable with respect to the sheath or the cable gland.

The cable gland further includes a still further threaded portion on the outer surface of the outer body. The still further threaded portion is located at a terminal end of the outer body that is most distal to the inner body.

The threads described can be conical or straight and left or right handed. They mate with corresponding screw threads on juxtaposed elements.

As is illustrated in FIG. 4, the harness connection assembly further includes an adaptor 452. The adaptor is a generally circular in cross-section and has a flattened cylindrical shape. The adaptor includes a central bore extending in the cylindrical axis. It will be appreciated that the central bore is a through hole. The circular inner surface 460 of the adaptor that defines the through hole is threaded. The adaptor thus cooperatively engages with the cable gland via the threaded inner surface of the adaptor and the still further threaded portion of the outer surface of the cable gland. The cable gland is thus not movable with respect to the adaptor. It will be appreciated that optionally the adapter may be a bracket.

The adaptor further includes two securing holes 464 that spatially correspond with the securing holes of the SCM housing. Thus, the securing elements 432 also pass through the adaptor to secure the adaptor to the housing. Thus, the adaptor is not movable with respect to the housing. Via the cable gland, the cable (including the cores) is not movable with respect to the housing. That is to say, the cable is retained at a predetermined position with respect to the housing.

Optionally any other number of securing holes may be disposed radially around the adaptor and/or SCM housing.

Optionally, by virtue of the compressing element of the cable gland, the sealing gland forms a substantially fluid tight seal to prevent any fluid passing through the cable gland.

FIG. 5 illustrates a further harness connection assembly 500. The harness connection assembly 500 of FIG. 5 includes a harness 505 (including an outer sheath 510 and multiple cores 515), a cable gland 520 and a wet-mate connector 525. It will be appreciated that the harness, the cable gland and the wet-mate connector are substantially the same as those described with respect to the harness cable assembly 400 of FIG. 4. The cable gland 520 thus engages with the harness 500 as described with respect to FIG. 4.

In the harness cable assembly 500 of FIG. 5, the cable gland 520 connects directly to the housing 530 of a SCM 535. The housing 530 includes an aperture 540 that is a through hole extending through a wall of the housing. The aperture 540 is defined by an inner annular surface 545 of the housing. The inner annular wall 545 is threaded with threading that cooperates with an outer threaded portion 560 (that is substantially the same as the still further threaded portion of the cable gland of FIG. 4) located at a terminal end 562 of an outer surface 564 of an outer body 565 of the cable gland 520. Thus, the cable gland, via the outer threaded portion 560, directly engages with the threaded inner annular wall 545 that defines the aperture 540 of the housing 530 to retain the harness 505 at a predetermined position with respect to the housing 530.

FIG. 6 illustrates a still further harness connection assembly 600 of a SCM. The harness connection assembly 600 of FIG. 6 includes a harness 605 (including an outer sheath 610 and multiple cores 615), and a cable gland 620. It will be appreciated that the harness 605, the cable gland 620 of FIG. 6 are substantially the same as those described with respect to the harness cable assembly 400 of FIG. 4. The cable gland 600 thus engages with the harness 500 as described with respect to FIG. 4.

The harness connection assembly 600 of FIG. 6 includes a bracket adaptor 630 which is generally cylindrical in shape and substantially hollow such that the bracket adaptor defines a chamber 631. The bracket adaptor 630 includes a flange portion 632 at a first end 634 of the bracket adaptor 630. It will be understood that the flange portion is a locating portion that helps secure the bracket adaptor 630 to an inner surface of a SCM housing 636 at a desired position. The bracket adaptor 630 flange portion 632 includes a plurality of securing holes 638 which spatially correspond with complimentary securing holes 640 arranged on the inner surface of the housing 636. As illustrated in FIG. 6, an elongate fastening element 642, for example a screw or bolt, can be arranged through the securing holes 638, 640 to secure the bracket adaptor 630 to the housing 636 inner surface. Alternatively, any other suitable fastening/securing method can be utilised.

A remaining end 644 of the bracket adaptor 630 includes an aperture 646. The aperture 646 is defined by an annular inner surface 648 of the bracket adaptor 630. The annular inner surface 630 is threaded with threading that is complimentary with, and cooperates with, with an outer threaded portion 650 (that is substantially the same as the still further threaded portion of the cable gland of FIG. 4) located at a terminal end 652 of an outer surface 654 of an outer body 656 of the cable gland 620. Thus, the cable gland, via the outer threaded portion, directly engages with the threaded annular inner surface that defines the aperture of the housing to retain the harness at a predetermined position with respect to the housing.

As illustrated in FIG. 6, the bracket adapter 630 spaces the portion of harness engaged with the cable gland 620 away from the housing 636. As can be seen in FIG. 6, the cores 615 extend through the cable gland and into the chamber 631 defined by the bracket adaptor 630. The sheath 610 of the harness however is terminated proximate to the cable gland such that the sheath 610 extends less far into the chamber 631 than the cores 615. Thus, there are regions of each core that are exposed (not covered by the sheath 610) that extend into the chamber 631.

In the harness connection arrangement 600 of FIG. 6, a plurality of solder cups/pots/buckets 656 are disposed within the chamber 631 defined by the adaptor bracket 630. Thus, the solder buckets of FIG. 6 are arranged within the SCM housing. Six solder buckets are illustrated in FIG. 6, however any suitable number of solder buckets may instead by utilised. It will be appreciated that the solder buckets are connected to a wet-mate connector 660 that is located at the housing 636 of the SCM. Aptly the solder buckets may each be connected to respective connection elements (for example pins and/or sockets) of the wet mate connector 660. Aptly the solder buckets may be connected to the wet mate connector via wires or the like.

As illustrated in FIG. 6, the cores 615 each extend into the chamber 631 towards a respective solder bucket and terminate at the respective solder bucket. That is to say, an exposed terminal end (an end not covered by the sheath 610) of each of the cores 615 is coupled to a respective solder bucket. Aptly the cores are coupled to the solder buckers by soldering. Optionally any other suitable method of coupling a core to a solder bucket could be utilised. Aptly the coupling method allows for transmission of signals, for example power and/or information and/or data and the like, to be passed from a core to the wet mate connector 660 via a respective solder bucket and vice versa.

Optionally bracket adaptor may be formed from a rigid material, for example a metal or a plastic or another polymer material. Optionally the bracket adaptor may be formed from an at least partly flexible material, for example a rubber or polymer material. Optionally the arrangement of the bracket adaptor and cable gland arrangement shown in in FIG. 6 reduces movement and/or flexing of the harness in a region within and/or proximate to the bracket adaptor.

Optionally the chamber may be flooded with fluid. Optionally the fluid is an oil. Optionally the oil is a dielectric oil. Optionally the fluid is pressurised. Optionally the fluid is an electrically insulating fluid.

FIG. 7 illustrates still another harness connection assembly 700 for a SCM. The harness connection assembly 700 of FIG. 7 includes. The harness connection assembly 700 of FIG. 7 includes a harness 705 (including an outer sheath 710 and multiple cores 715), a cable gland 720. It will be appreciated that the harness 705, the cable gland 720 of FIG. 7 are substantially the same as those described with respect to the harness cable assembly 700 of FIG. 7. The cable gland 720 thus engages with the harness 715 as described with respect to FIG. 4.

The harness connection assembly 700 of FIG. 7 includes a bracket adaptor 730 which is generally cylindrical in shape and substantially hollow such that the bracket adaptor defines a chamber 731. The bracket adaptor of FIG. 7 extends through a SCM aperture 732 provided in a wall 734 of a SCM housing 736. The terminal end 738 of the bracket adaptor 730 includes a flange portion 740 that is a locating portion that helps secure the bracket adaptor to the housing 736 at a particular position. The flange portion 740 is thus located outside of the SCM housing 736. A wet-mate connector 742 is arranged at the housing 736 and on top of flange portion of the bracket adaptor. The wet mate connector, the flange portion and the housing each have a plurality of spatially corresponding securing holes. That is to say that the securing holes are provided in each of the flange, the wet-mate connector and the housing such that when in a stacked arrangement as shown in FIG. 7, the respective securing holes overlap and effectively provide through holes that extends through the wet mate connection, the flange portion and the housing. Fasteners extend through the wet mate connector, flange portion and the housing to secure the wet-mate connector and the bracket to the housing.

The chamber of the bracket adaptor includes exposed cores of the harness and solder buckets much in substantially the same arrangement as described with respect to FIG. 6.

FIG. 8 illustrates a harness connection assembly in which two wire harnesses are connected to a wet mate connector. As illustrated in FIG. 8, the assembly includes an inverted Y-shaped splitter at a terminal end of a bracket adaptor which is similar to the bracket adaptor described in respect of FIG. 7. The Y-splitter includes two threaded apertures which are each connectable to a respective cable gland in a substantially similar way as has been described with respect to FIGS. 4 to 7. The cable gland is securable to a wire harness in a substantially similar way as has been described with respect to FIGS. 4 to 7.

As shown in FIG. 8 a splitter 805 is connected to the adaptor 810. It will be appreciated that a connection neck 815 of the splitter that includes a threaded outer surface is connected to the adaptor via a threaded inner surface of a connecting aperture 820 of the adaptor 810. The respective cable glands 825 are connected to connecting regions 830 of the splitter, and are secured to respective cables 835 of respective harnesses as described with respect to the single harness arrangements described in FIGS. 4 to 7. That is to say a threaded radially outer surface region of the respective cable glands are secured to respective radially inner threaded surfaces of the splitter so that both cable glands (and associated cables of the harness) are connected to the splitter. The splitter is a substantially Y-shaped splitter arrangement and thus the cables connected to the splitter (via the respective cable glands) make an angle of around 90 degrees at their connection points (or at the cable gland). Optionally the cables may make any other suitable angle with respect to each other.

FIG. 9 illustrates a section view of an umbilical arrangement of a wire harness. As illustrated in FIG. 9, the umbilical includes a plurality of wire cores. Aptly, the umbilical may include electrical wires, fibreoptic lines, hydraulic lines and the like. The umbilical may include armouring elements. The umbilical may include electrically insulating elements.

FIGS. 10 and 11 illustrate different views of an adapter bracket 1000. The bracket may be the same or a similar adapter bracket shown in any of FIGS. 4 to 7. In the section view shown in FIG. 10, the central bore is visible. The adapter bracket has a number of openings 1005. Optionally the openings 1005 are for permitting fluid communication between the interior of the adaptor and the interior of the housing of a subsea module in which the adaptor is at least partially located.

FIG. 11 shows how the adaptor bracket includes a number of apertures 1100 arranged circumferentially around a flange region 1110 of the bracket 1000 that are for receiving securing elements such as bolting or screws or the like for securing the adaptor 1000 to a housing of a subsea module and/or to a wet mate connector disposed at a housing of a subsea module.

FIG. 12 illustrates a top view of a wet-mate interface for a 4-way connector. The wet-mate interface has a number of concentric circles. In the region 1205 between the second-and third-most outer circles, six bolts can be seen. These bolts secure into the bracket. In the region 1210 constrained by the innermost circle, the 4 blind holes for the 4-way connector are visible. A protrusion 1215 on the outside of the outermost circle is displayed. This can be used to help provide correct axial orientation of the 4-way connector.

It will be appreciated that the 4-way connector shown can receive four pins of a cooperating connector for transmitting data/information/signals/power and the like from or to the subsea module to which the 4-way connector is connected. Optionally the 4-way connector shown may be a male connector and may include pins and the like.

FIGS. 13-16 illustrate different views of a wet-mate interface for a 4-way connector with a harness. This may be a similar arrangement to that shown in FIG. 7. A wet-mate connector 1305 is secured using bolts 1306 to a bracket 1310 and a module wall 1315. A collar 1325 of a harness body 1330 is secured into the bottom portion of the bracket 1310.

The wet mate connector 1305 shown in FIG. 13 is similar to the wet mate connector illustrated in FIG. 12. That is to say the wet mate connector 1305 illustrated is a 4-way connector. Optionally any other suitable wet mate connector may instead be utilised. FIG. 13 also illustrates how a bracket 1310 or adaptor is secured to the wet mate connector via respective flange (that is to say outwardly extending) regions 1350, 1352. It will be appreciated that the adaptor and the wet mate connector are secured to the housing 1315 of the subsea module (for example a SCM) by bolts that extend through or into the flange regions 1350, 1352 of the wet mate connector 1305 and the adaptor 1350 respectively, and also into or through the housing 1315. FIG. 13 illustrates how the adaptor 1310 extends through the housing of the subsea module. It will be appreciated that the adaptor extends through an aperture of the housing. It will also be appreciated that one or more seal elements such as seal rings may be arranged around the adaptor to prevent water ingress into the subsea module via the aperture when the subsea module is submerged in a subsea environment.

FIG. 14 illustrates a section view of a wet-mate interface for a 4-way connector with a harness. The wet-mate interface 1305 has a broadly cylindrical portion which is joined to a circular disc on one of its short ends. It will be appreciated that the disk is a flange region 1352 of the wet mate connector 1305. Optionally the circular disc and the remainder of the body of wet mate interface may be integrally formed. The circular disc contains a number of through-holes 1405 spaced apart at regular intervals. Two of the through-holes 1405 of can be seen in FIG. 14. The circular disc has a protruding lip around its inner radius. Inside this region are multiple cylindrical clips 1406. The cylindrical clips 1406 provide a means of connection to electrical wires. On the other short end 1205 of the broadly cylindrical portion of the wet-mate interface, there are four holes (not shown). The holes constitute the socket portion of the plug and socket arrangement; the plug is located on a cable which contains four pins that fit into the holes in the socket. The arrangement of the plug and socket is such that the cylindrical plug is aligned along the same axis as the socket. A short distance below the four holes, along a section of the radius of the cylindrical portion of the wet-mate interface, there is a cuboidal protrusion 1215. This protrusion helps the cylindrical plug of the cable to be is aligned in the correct axial orientation with the 4-way connector socket. Below the wet-mate interface in FIG. 14 there is a bracket 1325. This bracket is shown in more detail in FIG. 10 and FIG. 11.

The bracket has a ring-shaped region, a mouth and a cylindrical region. The bracket has rotational symmetry through an axis defined by the ring-shaped region and cylindrical region. The area along the internal circumference of the cylindrical region is threaded. There are a number of through-holes 1410 in the ring-shaped region of the bracket which can be aligned with the through-holes in the wet-mate interface. Below and around the bracket in FIG. 14, a section of the wall 1315 of an SCM is shown. It will be appreciated that the wall of the SCM provides an enclosed internal region which is partially shown in FIG. 14. The wall of the SCM is shown in more detail in FIG. 2. The wall of the SCM may also be referred to as the cover. The cover has a number of blind holes 1415 which align with the through-holes in the bracket and the wet-mate interface. The through-holes in the wet-mate interface and bracket, when combined with the blind holes in the SCM cover, provide a method of fastening the wet-mate interface, bracket and SCM cover together. In FIG. 14, two bolts are shown providing this method of fastening. A portion of a harness 1330 is shown in FIG. 14. This harness is shown in more detail in FIG. 3. The harness is cylindrical in shape and contains several cable cores 1450 which are visible at the end of the harness. This end region of the harness is known as the termination. Near but before the termination of the harness is a cable gland 1325. The cable gland is a concentric ring located on the outer radius of the harness. The cable gland has a thread along its outer circumference. The threaded outer circumference of the cable gland can be screwed into the internal circumference of the cylindrical region of the bracket, thus providing a method of mounting the harness to the SCM cover for attachment to the wet-mate interface.

It will be appreciated that the clips 1406 in FIG. 14 are solder buckets that are examples of intermediate transmitting elements. Aptly any other connection elements or clips for terminating wire/cable cores of the harness can be utilised. It will be appreciated that the wire/cable cores 1450 are exposed from the sheath 1454 of the harness and pass into the adaptor 1310. The housing of the subsea module provides a chamber 1458 and the adaptor (that is mostly located in the chamber 1458) provides an inner chamber 1462 that is also located in the chamber 1458 (of the housing). The wire cores 1450 thus extend into and through the inner chamber 1462 to terminate at the solder buckets 1406. The solder buckets 1406 of FIG. 14 are located at a terminal end of the wet mate connector 1305 that is connected to the adaptor 1310. That is to say that the wire cores 1352 are directly connected to the wet mate connector 1305. Optionally, the wire cores 1352 may not be directly connected to the wet mate connector 1305 and instead may be terminated at solder buckets 1406 that may be located within the adaptor 1310 and/or may be allocated on a rear surface of the wet mate connector 1305. For example, the solder buckets 1406 within the adaptor 1310 may be connected to the wet mate connector 1305 via further wires or the like. Alternatively, the solder buckets 1406 that terminate the wire cores 1450 may be located in a dry mate connector/interface, or the like, located at the terminal end of the adaptor 1310 that interfaces with a corresponding dry mate connector/interface on the rear of the wet mate connector 1305. It will be appreciated that the solder buckets are associated with the wet mate connector 1305 (that is an example of a transmitting connector).

As shown in FIG. 14, an individual wire core 1450 may be terminated at (and thus be connected to) an individual solder bucket 1406 (or other intermediate transmitting element). Optionally, more than one wire core 1450 may be terminated at a single solder bucket 1406.

FIG. 14 illustrates how a cable gland 1325 secures the cable of the harness to the adaptor. The cable gland shown in FIG. 14 is substantially similar to the cable gland discussed with respect to FIGS. 4 to 7. The cable gland includes a radially outer body 1480, a radially inner body 1484 and resilient body 1488. Optionally resilient body is an inner body and may not be resilient. The resilient body is an example of a compressing portion of the retaining element (cable gland). The radially outer body includes a threaded outer surface region which cooperates with a threaded inner surface region in a securing aperture at a terminal end of the adaptor. The cable gland thus can be secured to the adaptor. The radially outer body also includes a radially inner threaded surface that can cooperate with a radially outer threaded surface of the radially inner body of the cable gland. Thus, the radially inner and outer bodies of the cable gland can be secured together. The radially outer body of the cable gland includes a conical portion with a conical inner surface region that surrounds the resilient body. The resilient body is wedged between the conical inner surface of the radially outer body, and an end region of the radially inner body. Thus, when the cable gland is tightened (such that the radially inner and outer bodies are relatively rotated to bring these bodies closer together), the resilient portion is urged radially inwardly to secure against a region of the cable of the harness that is disposed within the cable gland. It will be understood that tightening of the inner and outer bodies of the cable gland (thereby urging the resilient body radially inwardly) provides a compressing force or a biting force on the outer sheath of the harness. It will be appreciated that the force provided on the harness cable by the cable gland compresses the cable and thus may optionally squeeze the wire cores of the harness together thus helping secure the wire cores within the cable. Thus, the cable gland secures the cable, including the wire cores of the cable, to the adaptor. It will be appreciated that the cable gland thus indirectly retains the wire cores to the adaptor. It will be appreciated how, by affixing the cable of the harness to the adaptor in such a way, load is reduced on the wire cores at or around the solder buckets and the cable (and the wire cores) are securely clamped by the cable gland and are retained at a position with respect to the adaptor and the housing of the subsea module.

It will be appreciated that the wire cores shown In FIG. 14 may optionally be electrical cores (for example copper wires and the like) or optionally may be communication carrying cores (for example DSL lines or ethernet lines or fibreoptic lines or the like).

With similarity to the adaptor shown in FIG. 10, the adaptor 1310 includes apertures in a side wall of the adaptor for permitting fluid communication between the inner chamber within the adaptor and the chamber within the housing of the subsea module. Thus fluid, such as dielectric oil, can flow between the chamber and the inner chamber. This helps maintain a pressure of the inner chamber with the pressure of the chamber within subsea module housing to reduce risk of damage to the harness arrangement due to pressure building up in the inner chamber.

It will be appreciated that the cable gland may be secured first to the adaptor and subsequently to the cable of the harness or vice versa. For example, the adaptor may first be secured to the outer surface of the housing by arranging the adaptor flange at the outer surface of the housing thereby allowing the remainder of the adaptor to sit through an aperture in a wall of the housing to extend into the housing. The exposed wire cores of the cable may then be (or may have previously been) connected to respective solder buckets located at an end region of a wet mate connector. The cable of the harness may thus then be arranged through the aperture of the housing and through a central channel of the adaptor (thereby extending through the inner chamber provided by the adaptor). The cable of the harness thus extends into the housing of the subsea module. The wet mate connector and adaptor can then be secured to the housing of the subsea module via bolts and the like. Finally, the cable gland can be provided inside the subsea module housing and can first be secured to the end of the adaptor located in the housing, and then finally be tightened around the cable of the harness (or vice versa).

It will be appreciated that the harness arrangement illustrated in FIG. 14 could optionally be connected to a housing of a subsea module by first arranging the adaptor 1310 and the wet mate connector 1305 at the outer surface of a wall of the housing 1315 proximate to where an aperture through the wall of the housing is located. It will be appreciated that arranging the adaptor 1310 and the wet mate connector 1305 in such a way involves arranging the respective flanges 1350, 1352 of the adaptor 1310 and the wet mate connector 1305 so that securing through holes disposed circumferentially around the flanges 1350, 1352 are aligned, and are also aligned with securing holes (that may be through holes or blind holes) in the wall of the housing 1315. It will be appreciated that arranging the adaptor and wet mate connector in such a way involves interspacing the flange 1350 of the adaptor 1310 between the housing and the wet mate connector 1305 so that the wet mate connector 1305 sits atop of the adaptor flange 1350. It will also be appreciated that arranging the adaptor in such a way involves allowing a generally cylindrical portion of the adaptor (that provides, defines or at least partly surrounds) in inner chamber of the adaptor to intrude into the housing 1315 through the aperture in the housing. The wet mate connector, adaptor and housing can thus be secured by passing securing elements 1411 through the through holes in the flanges 1350, 1352 of the wet mate connector and adaptor, and into or through the corresponding through holes in the housing. It will be appreciated that the disk/flange 1352 of the wet mate connector may be secured to the remainder of the wet mate connector body via welding or the like.

Subsequent to securing the wet mate connector 1305 and the adaptor 1310 to the housing 1315 of the module, the cable 1490 of the harness 1458 can be passed through an opening 1492 disposed at a terminal end region of the adaptor 1310 that is located most inside of the housing 1315. It will be appreciated that the adaptor 1310 include a bore or through passageway that extends through the adaptor. The cable 1490 can be received in this through passageway. The through passageway of the adaptor includes the inner chamber 1462. FIG. 14 shows how the wires cores 1450 are exposed from the sheath 1454 in the adaptor. It will be appreciated that the sheath 1454 in this region may have been cut away to reveal the wires cores 1450. It will be appreciated that the cable can be arranged such that the wire cores 1450 are located at least partly through the through passageway (and inner chamber 1462) of the adaptor 1310.

Once the wires cores 1450 and the cable 1490 are located in the correct position the terminal ends of the exposed with cores 1450 can be connected to the solder buckets 1406 for example via soldering. As shown in FIG. 14, the wires cores extends into and through the aperture of the module housing to connect to the wet mate connector (which sits in a recess in the flange 1350 of the adaptor). Optically, as previously discussed, the wire cores may not extend through the aperture of the housing and may be terminated within the housing at solder buckets. For example, the solder buckets may be connected to further wires or the like that extend through the aperture of the housing and/or the wet mate connector may protrude at least partly through the aperture of the housing.

Once the wires cores 1450 and the cable 1490 are located in the correct position, the cable can be secured to the cable gland (subsequent to threading the cable through a bore/through passageway of the cable gland so that the cable gland is located radially around a portion of the cable) via tightening the cable gland at a desired position of the cable 1490. The cable gland can also be connected to the adaptor by securing a threaded outer surface region of the cable gland to a threaded inner surface of the opening 1492 at the terminal end region of the adaptor. Thus, the cable is secured to the housing via the cable gland and the adaptor. This helps minimise load on the wire cores and/or the solder buckets.

It will be appreciated that the wire cores 1450 being connected to the solder buckets 1406, the cable gland being secured around the outer surface (and outer sheath 1454) of the cable 1490, and the cable gland being secured to the adaptor may be done in any desired order.

Alternatively, it will be appreciated that the harness arrangement illustrated in FIG. 14 could optionally be connected to a housing of a subsea module by first connecting exposed wires cores 150 (that is to say wires cores 1450 that are exposed from a sheath 1454 of a cable 1490) to solder buckets 1406 (or other suitable intermediate transmitting elements) disposed on a rear surface of a wet mate connector. The adaptor 1310 could then either be slid over the cable 1490 (or the cable located/threated through the bore/through passageway of the adaptor) so that the adaptor is located against the rear of the wet mate connector 1305, or could be arranged at the outer surface of a housing wall 1315 proximate to an aperture through the wall of the housing 1315 so that the flange 1350 of the adaptor sits on the housing outer wall 1315 and the cylindrical portion 1494 of the adaptor 1310 intrudes into the housing through the aperture. In the latter case, the cable can then be threaded or passed through the through passageway/bore of the adaptor (thereby also being passed through the housing aperture and into the housing) so that the wet mate connector 1305 sits atop of the adaptor 1310. In the former case, subsequent to threading the cable 1490 through the bore of the adaptor 1310, the cable is passed into the housing via the aperture so that the adaptor flange 1350 and the wet mate connector 1305 sit at the outer surface of the housing 1315 (the adaptor flange 1350 being interspaced between the housing and the wet mate connector). The wet mate connector 1305 and adaptor 1310 can then be secured to the housing 1315 as has been described above.

FIG. 15 illustrates a different perspective view of the wet mate interface shown in FIGS. 12 to 14. FIG. 15 helps illustrate how the wet mate connector 1305 is connected to a flange of the adaptor/bracket 1310 which passes through the housing 1315 of a subsea module. FIG. 15 also shows how the adaptor is secured between the housing and the wet mate connector, the wet mate connector, adaptor and housing all being connected via bolts (or the like) that pass through correspondingly spaced openings in the wet mate connector, adaptor and housing.

Subsequent to the cable being located in the housing, via the housing aperture, the cable gland can be secured to the cable and to the adaptor as has been described above.

FIG. 16 illustrates another perspective view of the wet mate interface and harness arrangement illustrated in FIGS. 12 to 15. FIG. 16 illustrates how respective bolts extends through the wet mate connector 1305, the adaptor 1310 and a wall 1315 of a housing of a subsea module to thereby secure the wet mate connector and adaptor to the subsea module housing.

FIG. 17 illustrates a top view of a wet-mate interface for a 12-way connector. The wet-mate interface has a number of concentric circles. In the region 1705 between the second-and third-most outer circles, six bolts can be seen. These bolts secure into the bracket. In the region 1710 constrained by the innermost circle, the 12 blind holes for the 12-way connector are visible. A protrusion 1715 on the outside of the outermost circle is displayed. This is used for correct axial orientation of the 12-way connector.

FIGS. 18-20 illustrate different views of a wet-mate interface for a 12-way connector with a harness. This may be a similar arrangement to that shown in FIG. 7. The socket 2005 containing 12 blind holes for the 12-way connector is visible in the wet-mate interface in FIG. 20.

The wet mate connector shown in FIGS. 18 to 20 may be the same as or substantially similar to the wet mate connector shown in FIG. 17.

It will be appreciated that the 12-way connector illustrated in FIGS. 17 to 21 is substantially the same as the 4-way connector described with respect to FIGS. 12 to 16 but has a different number of connection elements located at an exposed or terminal end of the wet mate connector. The associated harness may additionally have an increased number of cores.

FIG. 18 illustrates how the 12-way connector arrangement illustrated in FIGS. 17 to 21 includes a wet mate connector 1805 that is connected to an adaptor disposed through an opening in a subsea module housing. It will be appreciated that this is arranged in a similar manner to the 4-way connector arrangement discussed with respect to FIGS. 12 to 16. FIG. 18 also shows how a harness 1820 is connected to the adaptor. More specifically, a cable gland 1825 secures to a cable 1830 of the harness 1820 and also secures to the adaptor 1810 in much the same way as is described with respect to FIGS. 12 to 16.

The arrangement shown in FIG. 18 includes a harness 1820 (including a cable and a cable gland) and an adaptor to which the cable gland is secured. As shown in FIG. 18, a wet mate connector 1805 is connected to a generally cylindrical adaptor 1810 that additionally includes a flange portion 1812. Aptly the adaptor 1810 may be of any suitable shape. The adaptor 1810 shown in FIG. 18 includes a number of apertures 1850 or holes in the side walls of the adaptor 1810. FIG. 18 also shows how the adaptor 1810 at radially surrounds (or defines) an inner chamber 1855. It will be appreciated how the housing 1815 of a subsea module in use would provide a chamber 1860 in which the adaptor 1810 (and thus the inner chamber 1855) are located. It will be appreciated that the apertures 1850 provide fluid communication between the chamber of the subsea module (provided by the housing) and the inner chamber of the adaptor 1810. Thus. The inner chamber 1855 of the adaptor 1810 and the chamber provided by a subsea module housing 1815 are maintained at an equivalent pressure due to fluid communication through the apertures 1850. It will be appreciated that filling a subsea module with a fluid, for example a dielectric oil, also fills the inner chamber 1855 with the fluid and maintains the inner chamber at the same pressure or at a similar pressure as the remainder of the subsea module. This helps prevent pressure buildup in the adaptor which can cause damage when the subsea module is arranged deep underwater (where the environmental pressure is significant).

FIG. 18 also illustrates how the harness arrangement 1820 includes a retaining element 1825 which is disposed radially around a cable 1830 of the harness. The retaining element 1823 of FIG. 18 is secured to the outer surface of the cable 1830. It will be appreciated that the retaining element 1825 may be able to be tightened (thereby reducing the diameter of an inner bore that extends through the retaining element 1825) so that a radially inner surface of the retaining element 1825 (which constitutes a first retaining portion of the retaining element of FIG. 18) is secured against the cable 1830 (that is to say against the outer sheath of the cable 1830). The retaining element 1825 shown in FIG. 18 is a cable gland and is similar to the cable glands described above. That is to say, the cable gland 1825 includes two (or more) body portions that are securable via cooperating threaded surfaces. For example, an inner body portion includes a threaded radially outer surface, and an outer body portion includes a threaded radially inner surface. Thus, the inner and outer body portions are securable and can be tightened via threading. Additionally, the cable gland 1825 includes a resilient portion radially within a generally conical radially inner surface region of the outer portion and axially between a seat region of the inner surface and the generally conical radially inner surface. Thus, when the outer body portion of the cable gland 1825 is rotated with respect to the inner portion (to axially reduce the spacing between the inner and outer portion), the cable gland is tightened, and the resilient portion is urged radially inwardly to secure around the cable 1830 (or more specifically around an outer sheath of the cable 1830).

It will be appreciated that alternatively, the retaining element 1825 may be secured to the cable 1830 by other mechanisms. For example, the retaining element may be integrally formed with the sheath of the cable or may be glued or moulded onto the cable for example.

FIG. 19 helps illustrate how various wire cores 1905 extend through an inner chamber of the adaptor to connect to solder buckets, cups or clips on a rear surface of the wet mate connector 1805 in much the same way as is descried with respect to FIGS. 12 to 16. Optionally the solder buckets may instead be located within the adaptor and may be connected to the wet mate connector via further connection elements.

FIG. 19 illustrates the arrangement of FIG. 18 in partial cross section. FIG. 18 illustrates how the cable gland 1825 is secured around the cable 1830 of the harness illustrated (that includes the cable and the cable gland). FIG. 18 also helps illustrate how the cable gland 1825 is secured to a terminal end of the adaptor 1810 via a connection aperture 1920 of the adaptor 1810. That is to say, a threaded radially outer surface 1924 of the cable gland 1825 cooperates and secures with a threaded radially inner surface 1928 of the connection aperture of the adaptor 1810.

FIG. 19 shows how respective wire cores 1905 extend through the chamber 1855 provided by the adaptor 1810 and connect to solder buckets 1950 or caps or the like. Alternatively, any other suitable connection elements (that are examples of intermediate transmitting elements) may instead be utilised instead of solder buckets. It will be appreciated that the wire cores 1905 of the cable 1830 may be single current carrying wires or bundles of current carrying wires or the like. Alternatively, the wire cores may be single or bundles of fibreoptic elements or ethernet lines or the like. It will be appreciated that the solder buckets 1905 are associated with the wet mate connector 1805. The solder buckets 1905 of FIG. 19 are located on a rear surface of the wet mate connector 1805 and thus the wire cores are connected directly to the wet mate connector. It will be appreciated the solder buckets may alternatively be included in a dry mate interface at, or proximate to, a terminal end of the adaptor 1810 that connects with a dry mate interface on a rear end of the wet mate connector. Alternatively, the solder buckets 1905 may be interfaced directly into the wet mate connector via further wires and the like. Thus, signals provided through the harness 1820 illustrated in FIG. 19 can be transmitted out of a subsea module (or any other such module in which the harness arrangement illustrated is disposed) via the wet mate connector 1905. It will be understood that the wet mate connector 1805 includes multiple connection elements (that are sockets but may optionally alternatively be pins or clips or crimps or the like) at an exposed end of the wet mate connector 1805 (that is not connected to the adaptor 1810). Alternatively, the wet mate connector may include only a single connection element.

It will be appreciated that the wire cores 1905 of the harness shown may interface directly with connection elements (for example clips or solder buckets or the like) that are located on a rear surface of the wet mate connector to thereby directly connect the harness to the wet mate connector.

The wet mate connector illustrated in FIG. 19 includes a first flange 1960. The adaptor illustrated in FIG. 19 includes a further flange 1812. FIG. 19 helps illustrate how the wet mate connector sits in a recess provided in the flange of the adaptor. One or more seal rings may be located around the portion of the wet mate connector that sits in the inner flange recess, and/or between the adaptor and the wet mate connector, and/or between the adaptor and the housing, to help prevent water ingress into the subsea module through the aperture in the housing of the subsea module. It will be appreciated that the wet mate connector 1805 can be secured to the adaptor 1810 (in the recess of the inner flange) via welding and the like.

FIG. 20 illustrates another perspective view of the arrangement shown in FIGS. 17 to 19. FIG. 23 helps illustrate how a wet mate connector 1803 is connected to a housing 1815 of the module via an adaptor 1810.

FIG. 21 illustrates a different partially transparent isometric view of a wet-mate interface for a 12-way connector 2105 with a harness 2110. This may be a similar arrangement to that shown in FIG. 7. The harness is held securely in place by the bracket adapter 2115. A portion of the bracket protrudes below the cover 2120 in the SCM through a cutout in the cover. Two of the openings 2125 in the bracket 2115 are visible. These openings enable fluid to flow into the gaps inside the bracket and around the region between the harness and the wet-mate interface. This prevents a pressure differential between the space outside the bracket, which is filled with a dielectric oil, and the space inside the bracket. The interface between the cable gland 2130 and the adapter 2115 is shown more clearly. The outer circumference of the cable gland and the inner circumference of the bracket 2115 are both threaded. In FIG. 21, the cable gland 2130 is screwed into its furthest position in the bracket 2115.

The harness arrangements described with respect to FIGS. 2 to 21 optionally include connection regions at one or both ends of the harness. Optionally the connections regions include a plug (male) or socket (female) type/arrangements.

The wet mate connectors discussed with respect to FIGS. 2 to 21 optionally provide an electrical and/or communication solution. That is to say that the wet mate connectors can help transmit electrical and/or communication signals in underwater environments.

The wet mate connectors discussed with respect to FIGS. 2 to 21 optionally help prevent ingress of water into connectors (such as the wet mate connector itself for example), and/or a harness that is connector to the mate mater connector (such as to the rear of the wet mate connector) and/or a unit that the wet mate connector is mounted/attached to (for example a SCM, a PCDM, a downhole interface unit (DIU) or other subsea module or the like).

In the harness arrangements shown in FIGS. 2 to 21, it will be appreciated that optionally wires/wire cores in the harness may be connected to a wet mate connector via clips or solder buckets or by crimped/twisted regions of respective wire cores and wires (or other suitable elements) of the wet mate connector or by pins or by sockets or by butt connectors (for example crimp butt connectors) or the like. Optionally these are examples of intermediate transmitting elements.

Optionally the wet mate connectors of FIGS. 2 to 21 may be for carrying electrical and/or communications signals, for example DSL/ethernet/fibre or the like. Optionally the harness similarly may include cores that are for electrical signals (such as copper wires or the like) and for communications such as DSL lines/ethernet lines/fibreoptic lines.

The harness arrangements described with regard to FIGS. 2 to 21 may optionally be utilised in subsea distribution systems (SDSs) and/or subsea productions systems (SPSs) and the like.

It will be appreciated that subsea modules may optionally include jumpers and/or flying leads and/or harnesses and the like. Optionally the harnesses may be internal and/or external to a subsea module. Optionally the subsea module is FAT'd before being deployed subsea.

Optionally, with regard to the harness arrangements described with respect to FIGS. 2 to 21 the method of securing an internal harness of a module (that optionally is a subsea module) to the rear of a wet mate connector may be via a soldered/crimped solution into the solder buckets, optionally with a boot seal or the like to protect the joint against the surrounding dielectric oil or any other fluid, i.e. sea water/water gylcol or alike.

Aptly the arrangements illustrated in FIGS. 2 to 21 may include subsea production modules (for example SCMs and PCDMs and downhole interface units or the like) and may be connected together. Optionally a module may include one or more EFL/Harness that optionally is external to the module. Optionally such a harness can interface to wet mate connectors (that may be electrical/electrical+comms/comms only). Optionally the modules may include one or more internal harness that is included in the EDS system within the module (the EDS system optionally being electrical/electrical+comms/comms only). Optionally an internal harness connects to the rear of the wet mate connectors.

It will be appreciated that the arrangements illustrated in FIGS. 6 to 22 optionally help provide/connect an electrical or optical or data connector with a wet-mate connector or subsea control module (SCM) or PCDM by using an adapter or bracket.

It will be appreciated that, with regard to FIGS. 2 to 21, cable glands optionally provide mechanical restraint of the harness hose and a bracket may optionally be utilised to secure the cable gland to the electrical connector. The cable gland optionally supports the harness (when secured to a module housing or an adaptor that is secured to the module housing) and reduces a risk of failure of the harness.

It will be understood that, with regard to FIGS. 2 to 21, harness cores are optionally free flooded with dielectric oil or another suitable fluid.

It will be understood that, with regard to FIGS. 2 to 21, the harness arrangements illustrated may optionally be backwards compatible with preexisting subsea modules (such as SCMs and PCDMs and the like).

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. Apparatus for connecting at least one elongate transmitting element to a transmitting connector via at least one intermediate transmitting element, comprising:
a transmitting connector locatable at an outer surface of a housing that defines a chamber:
at least one elongate transmitting element locatable at least partly within the housing; at least one intermediate transmitting element associated with the transmitting connector and couplable to the elongate transmitting element; and.
a retaining element locatable within the housing and comprising a first retaining portion and a further retaining portion, the first retaining portion being for retaining the elongate transmitting element at a particular position with respect to the retaining element, and the further retaining portion being for engaging with a securing region associated with the housing;
wherein the retaining element is for retaining the elongate transmitting element at a predetermined position with respect to the housing.

2. The apparatus as claimed in claim 1, further comprising: the first retaining portion is for engaging with the elongate transmitting element.

3. The apparatus as claimed in claim 1, further comprising: the first retaining portion is for indirectly engaging with the elongate transmitting element.

4. The apparatus as claimed in claim 3, further comprising:
at least one intermediary element interspaced between the first retaining portion and the elongate transmitting element, the intermediary element optionally being a sheath in which the elongate transmitting element is disposed.

5. The apparatus as claimed in claim 1, further comprising:
an adaptor wherein at least part of the adaptor is interspaced between the retaining element and the housing.

6. The apparatus as claimed in claim 5, further comprising:
the adaptor is locatable through a first aperture provided in the housing or is securable to an inner surface of the housing.

7. The apparatus as claimed in claim 5, further comprising:
the adaptor comprises a locating portion at a first end of the adaptor that is securable to the housing or is locatable between the housing and the transmitting connector.

8. The apparatus as claimed in claim 5, further comprising:
the adaptor at least partly surrounds or defines a further chamber.

9. The apparatus as claimed in claim 8, further comprising:
the intermediate transmitting element is locatable within the further chamber and the elongate transmitting element can be terminated at and is connectable to the intermediate transmitting element.

10. The apparatus as claimed in claim 5, further comprising:
at least one further aperture through a wall of the adaptor that is for permitting fluid communication between a first region that is located within the housing but external to the adaptor and a further region that is located within the housing and within the adaptor.

11. The apparatus as claimed in claim 10, further comprising:
the further region is located within the further chamber.

12. The apparatus as claimed in claim 5, further comprising:
the adaptor comprises the securing region.

13. The apparatus as claimed in claim 12, further comprising:
the securing region comprises a threaded through hole.

14. The apparatus as claimed in claim 1, further comprising:
the housing is an external housing of a subsea module for example a subsea control module, or a power and communications distribution module, or a power distribution and protection module, or a subsea electronics module.

15. The apparatus as claimed in claim 1, further comprising:
the transmitting connector is a wet mate connector.

16. The apparatus as claimed in claim 1, further comprising:
the intermediate transmitting element is a solder bucket or a solder cup.

17. The apparatus as claimed in claim 1, further comprising:
the housing is filled with a fluid that optionally is a dielectric oil.

18. A method of connecting at least one transmitting element to a transmitting connector via at least one intermediate transmitting element, comprising the steps of:
providing at least one elongate transmitting element at least partly within a housing;
coupling the elongate transmitting element to at least one intermediate transmitting element associated with a transmitting connector that is at an outer surface of the housing;
retaining the elongate transmitting element at a particular position with respect to a retaining element via a first retaining portion of the retaining element; and.
engaging a further retaining portion of the retaining element with a securing region that is associated with the housing to thereby retain the elongate transmitting element at a predetermined position with respect to the housing.

19. The method as claimed in claim 18, further comprising:
securing an adaptor that comprises the securing region to an inner surface of the housing or between the housing and the transmitting connector, the intermediate transmitting elements being located within the adaptor thereby locating the elongate transmitting connector at least partly within the adaptor.

20. A system, comprising:
a subsea module comprising a housing;
at least one transmitting connector located at an outer surface of the housing;
at least one intermediate transmitting element associated with the transmitting connector;
at least one elongate transmitting element disposed within the housing and connected to the intermediate transmitting element; and
a retaining element comprising a first retaining portion that retains the elongate transmitting element at a particular position with respect to the retaining element, and a further retaining portion that is engaged with a securing region associated with the housing;
wherein the retaining element retains the elongate transmitting element at a predetermined position with respect to the housing.
